(19) United States
(12) Patent Application Publication
(10) Pub. No.: US 2008/0015889 A1
(43) Pub. Date: Jan. 17, 2008

(54) System and apparatus for managing risk

(76) Inventor: Brad Fenster, Lexington, KY (US)

Correspondence Address: STOCKWELL & SMEDLEY, PSC, 861 CORPORATE DRIVE, SUITE 200, LEXINGTON, KY, 40503, US

(21) Appl. No.: 11/825,908

(22) Filed: Jul. 10, 2007

Related U.S. Application Data
(60) Provisional application No. 60/831,299, filed on Jul. 17, 2006.

(51) Int. Cl. G06Q 10/00

(52) U.S. Cl. 705/1

(57) ABSTRACT

A system for managing risk is disclosed. The system provides a consistent approach for risk management and protection of non-public information, as well as providing for regulatory compliance and facilitating regulatory examinations.

### CROSS-REFERENCE TO RELATED APPLICATIONS

This application claims priority to U.S. Provisional Application No. 60/831,299, which was filed on Jul. 17, 2006.

### FIELD OF THE INVENTION

This invention relates generally to a system for managing risk, and more specifically for use by banks and other institutions regulated by the FDIC, or other regulatory agency.

### BACKGROUND OF THE INVENTION

Businesses and commercial endeavors must carefully track and monitor their various risk factors. Consequently, a mechanism for managing risk is desired.

### SUMMARY OF THE INVENTION

The present invention provides a software mechanism for managing risk. In addition, the present invention provides business continuity planning, vendor management, and audit planning.

The present invention further provides a framework to manage and report information security and information technology risks. This framework provides a direct correlation between risks, controls, policies, and audits. Some of the key features of the present invention include enterprise-wide risk assessment, reduction, and reporting; business continuity planning and reporting; audit planning and tracking of findings; information asset inventorying, and vendor management tracking and reporting.

Some of the key benefits of the present invention include reducing a company's risk profile by providing a systematic and consistent approach for risk management and protection of non-public information; providing for regulatory compliance and facilitates regulatory examinations as documentation of risk management is clearly defined in a central location; promoting institutional knowledge by staff, managers, and the Board of Directors; and reducing overall costs by allowing cost-benefit decisions prior to implementing any particular risk mitigation strategy. These and other objects and advantages of the invention will become readily apparent as the following description is read in conjunction with the accompanying drawings.

### BRIEF DESCRIPTION OF THE DRAWINGS

FIG. 1A is an overview of the present invention;

FIG. 1B is an user interface of the present invention;

FIG. 2 is an executive dashboard of the present invention;

FIG. 3 shows a hierarchy of the present invention;

FIGS. 4A-4F are further example user interfaces of the present invention;

FIGS. 5A-5F are further example user interfaces of the present invention;

FIG. 6 is a further example user interface of the present invention;

FIGS. 7A-7D show further example user interfaces of the present invention;

FIG. 8 shows a hierarchy of the present invention;

FIG. 9 is a further example user interface of the present invention;

FIGS. 10A-10C are further example user interfaces of the present invention;

FIGS. 11A-11C are further example user interfaces of the present invention;

FIGS. 12A-12C are further example user interfaces of the present invention;

FIGS. 13A-13B are further example user interfaces of the present invention;

FIG. 14 is a further example user interfaces of the present invention;

FIG. 15 shows a hierarchy of the present invention;

FIG. 16 is a further example user interface of the present invention;

FIG. 17 is a further example user interface of the present invention;

FIGS. 18A-18B are further example user interfaces of the present invention;

FIGS. 19A-19C are further example user interfaces of the present invention;

FIG. 20 is a further example user interface of the present invention;

FIG. 21 is a further example user interface of the present invention;

FIGS. 22A-22C are further example user interfaces of the present invention;

FIG. 23 shows further example user interfaces of the present invention;

FIG. 24A is a further example user interface of the present invention;

FIG. 25 is a further example user interfaces of the present invention;

FIGS. 26A-26B are further example user interfaces of the present invention;

FIG. 27 is a further example user interface of the present invention;

FIGS. 28A-28B show further example user interfaces of the present invention;

FIGS. 29-30 are flow diagrams of the present invention; and

FIG. 31 is an administrator user interface used within the present invention.

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

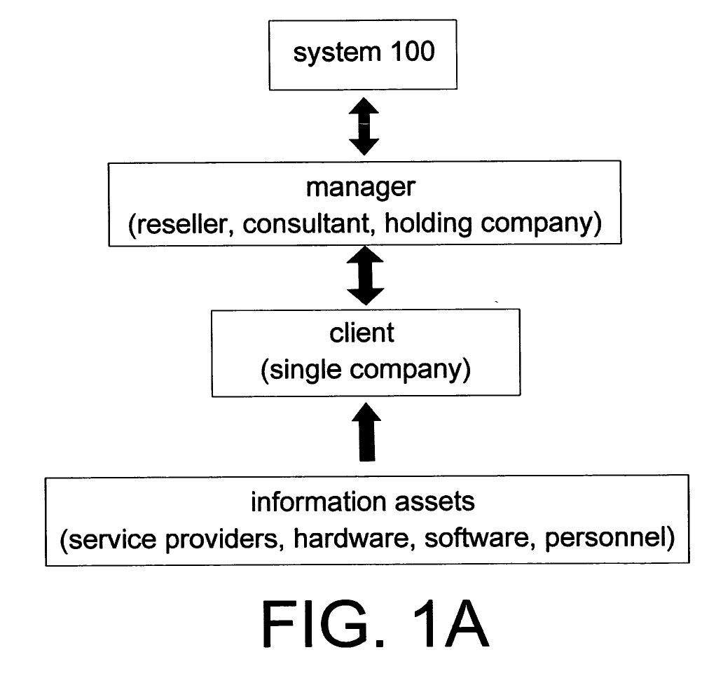

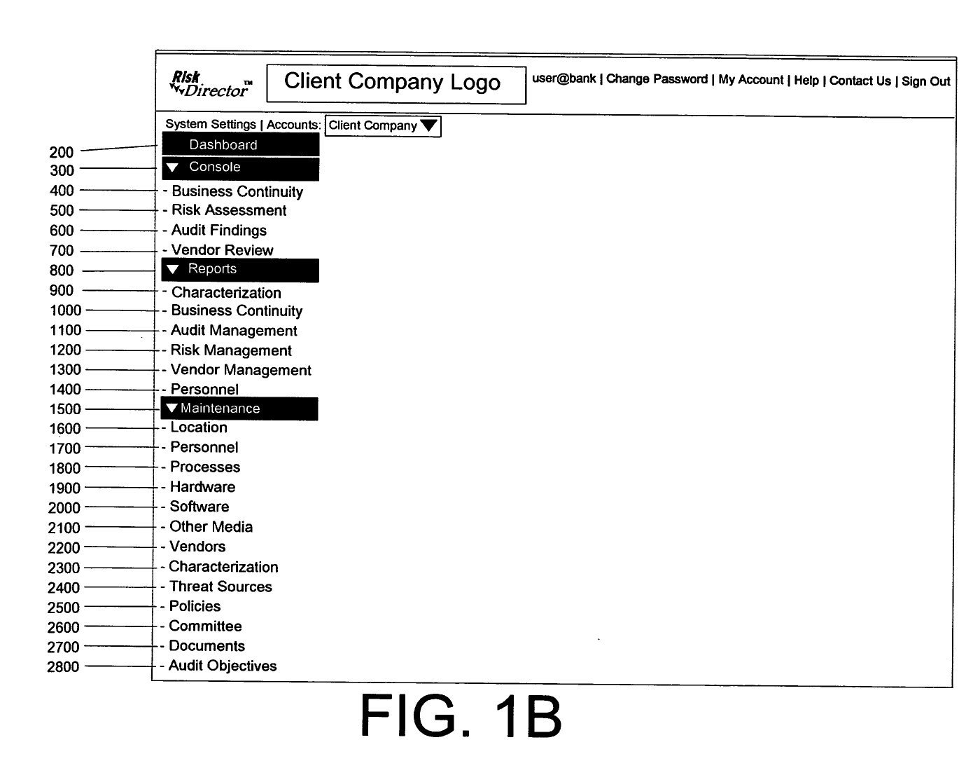

As shown in FIG. 1, the system 100 of the present invention provides a resource for a company, such as a commercial bank or other financial institution (Client) to establish a risk management framework that will facilitate developing a sound control environment, business continuity planning, and oversight of critical service providers (i.e. vendors). Client access to system 100 is provided by a Manager. The Manager may be any entity, such as a reseller, holding company, or security consultant, that has been authorized the right to add Clients. The Manager can access all of its Client information. The Manager also has access to various default lists used to populate the various used by the Client. The Client then provides access to individual end-users (such an employee), that can modify the Client data.

The current invention focuses on the financial industry. As such, the examples herein, and the default data incorporated into the invention relate to the financial industry. However, the invention could be used for other industries.

Although the invention assists with regulatory compliance, the invention is designed to provide a framework to manage risk to the confidentiality, integrity, and availability of information assets. By managing these risks properly, a financial institution would be complying with applicable regulatory mandates, such as the Interagency Guidelines Establishing Information Security Standards that implement the security requirements required by the Gramm-Leach-Bliley Act of 1999.

The system 100 is implemented as a single web application, accessible over the Internet via a secured communication channel. Managers and Clients access an instance of system 100 through an Internet browser on their local computer. The number of Managers and Clients is capped only by any hardware or processing limitations. Being a web application, the present invention could be installed on any web server with appropriate hardware and database support, such as the local network of a Client.

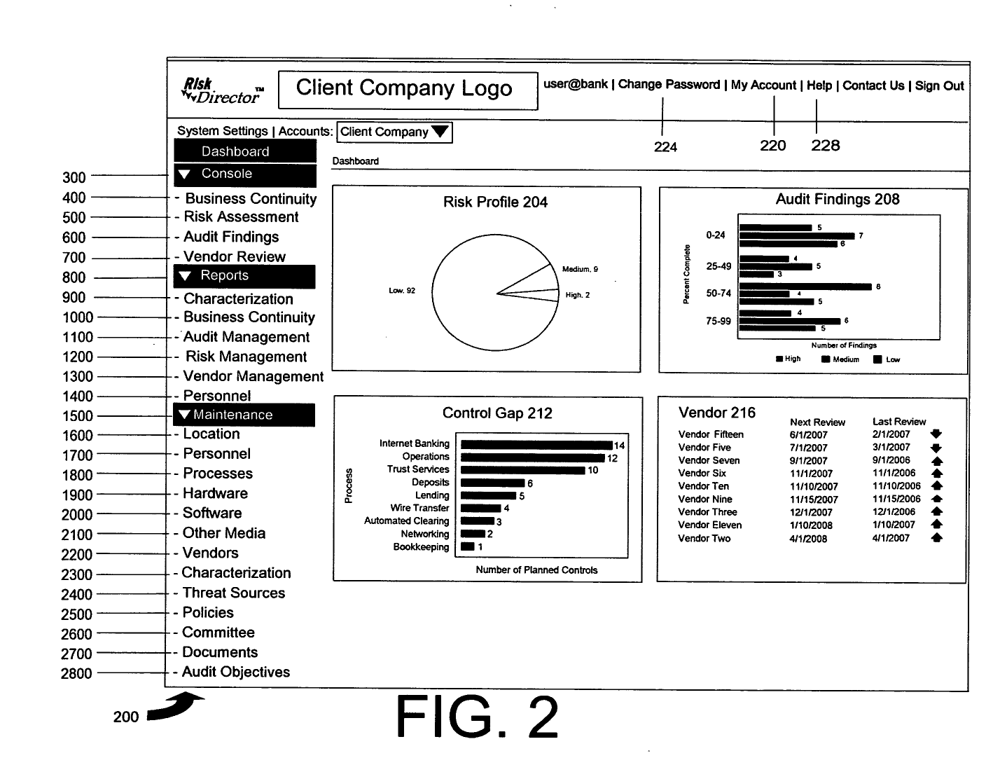

As shown in FIG. 2, the system 100 of the present invention is organized into four main components, a dashboard menu 200, a console menu 300, a reports menu 800, and a maintenance menu 1500, with numerous tabs located underneath. The console menu 300 is used to conduct most of the risk management tasks, such as identifying and mitigating risk. The reports menu 800 is used to view the information derived from the various risk management tasks. The maintenance menu 1500 is for entering information the does not change frequently. For example, most Clients do not change physical locations very often. Thus, this information can be held within the maintenance menu 1500. Other supporting data entry items are held in the maintenance menu 1500.

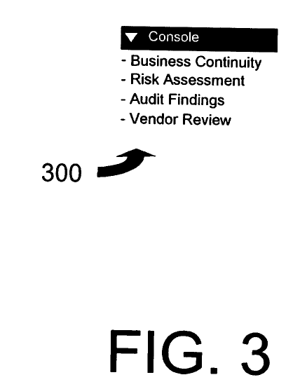

Throughout this document, the functionality of the invention will be discussed in the order of the menus on the left side of the user interface (FIG. 2). This is done for clarification. In actual practice, the end-user would not necessarily use the invention in this order. For instance, the information detailed in the maintenance menu 1500 would generally be populated before any of the risk management functions available in the console menu 300 are attempted. However, once the maintenance information is populated, the majority of risk management tasks would then be completed through the console menu 300, by accessing the various tabs shown in FIG. 3.

The dashboard 200 provides a display of various risk management components, and allows the end-user a quick reference of several key risk management areas. The dashboard 200 includes a risk profile chart 204, audit findings chart 208, and control gap chart 212, and vendor review table 216.

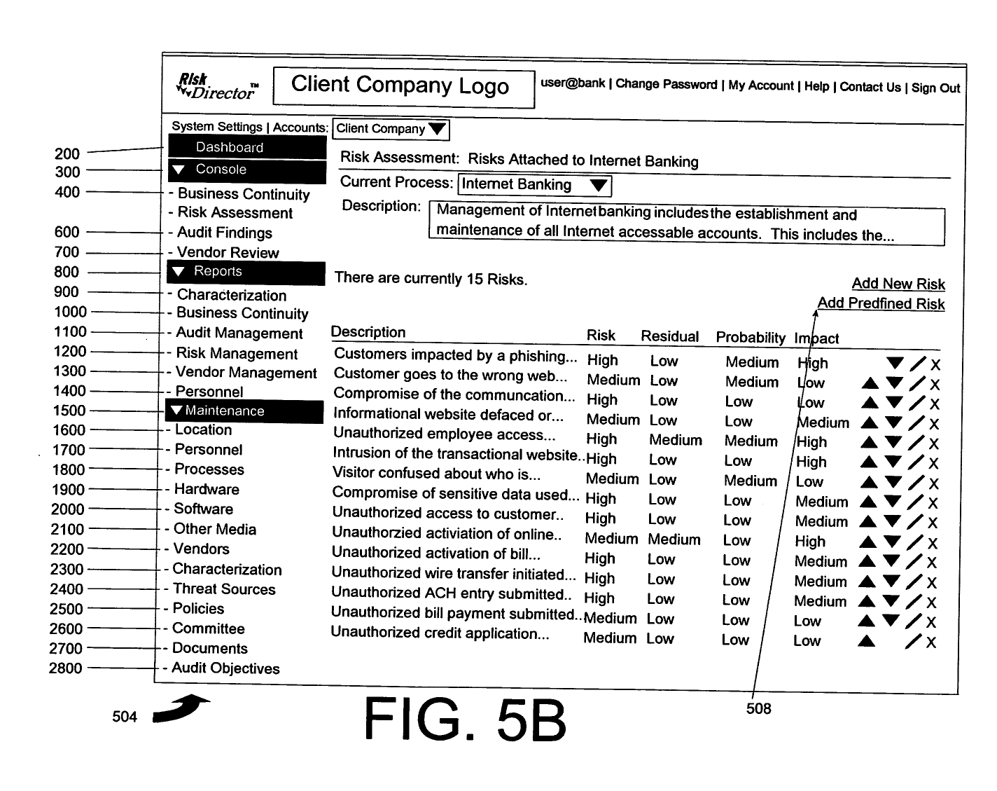

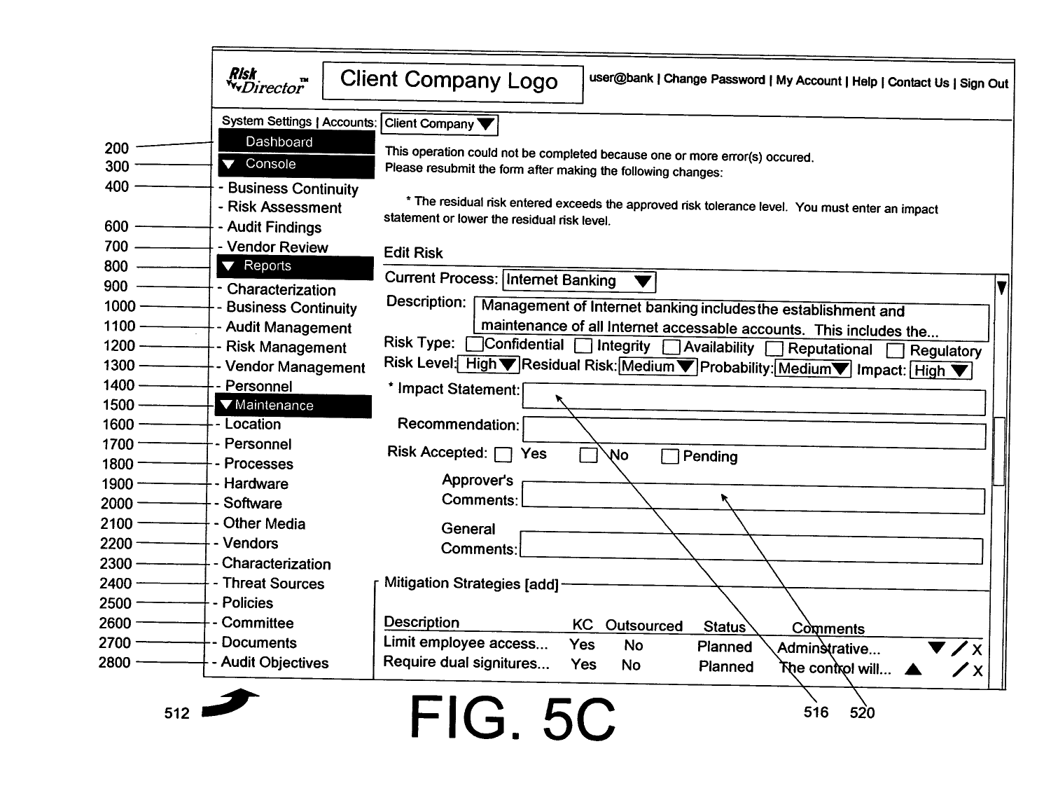

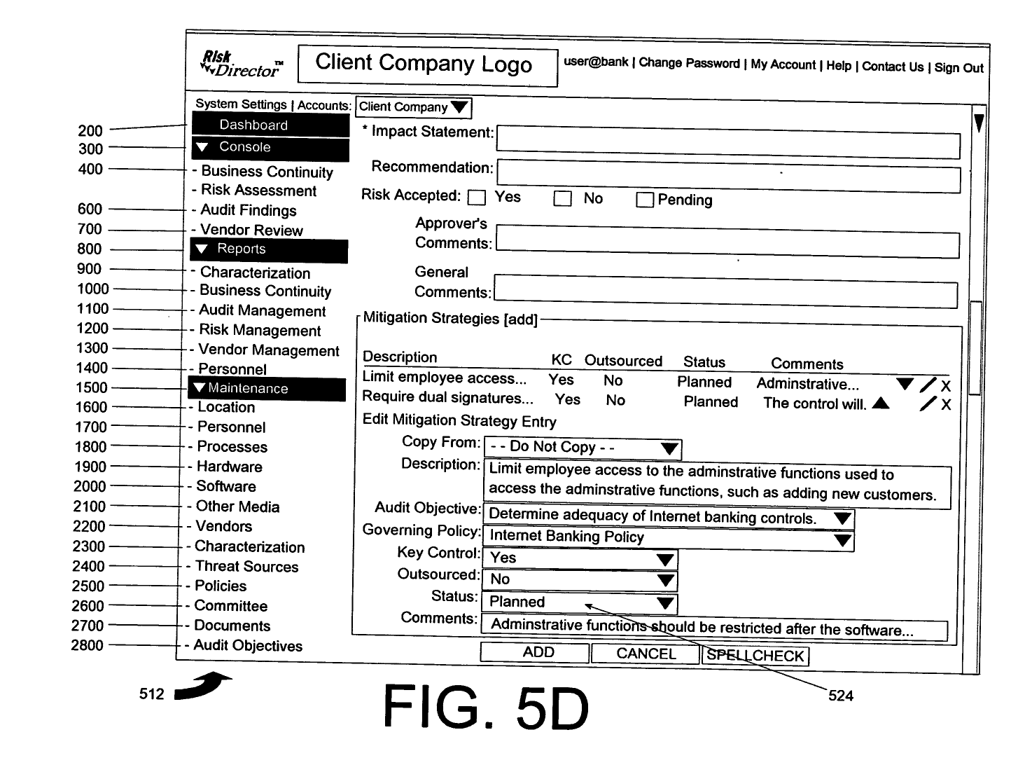

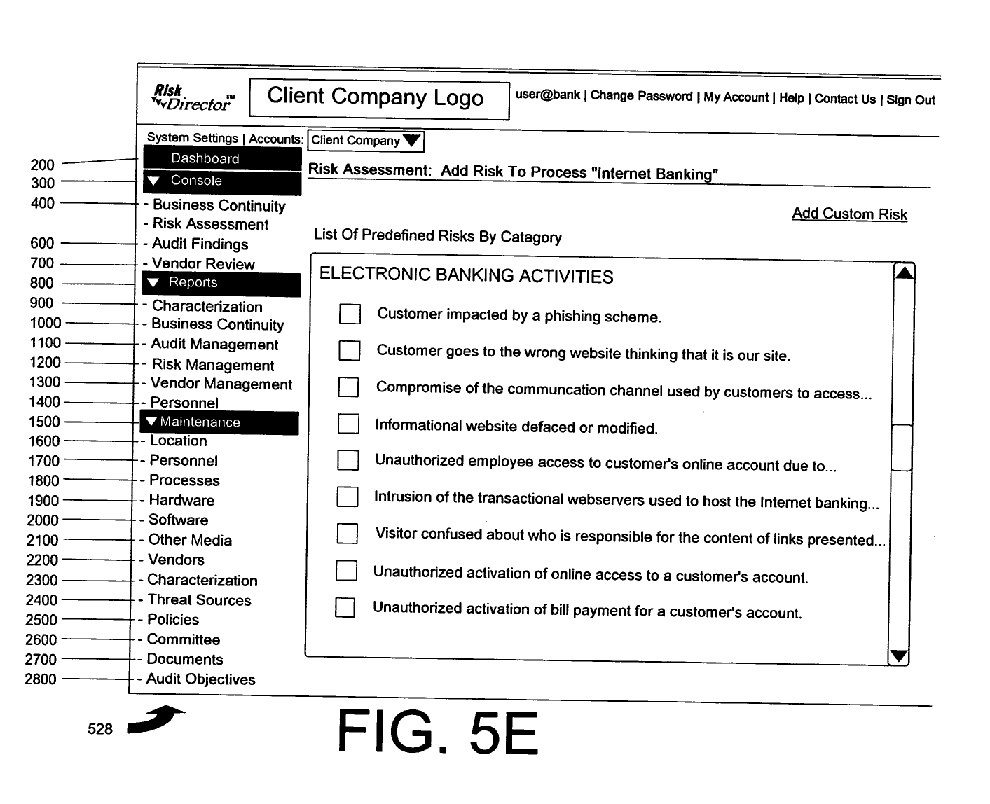

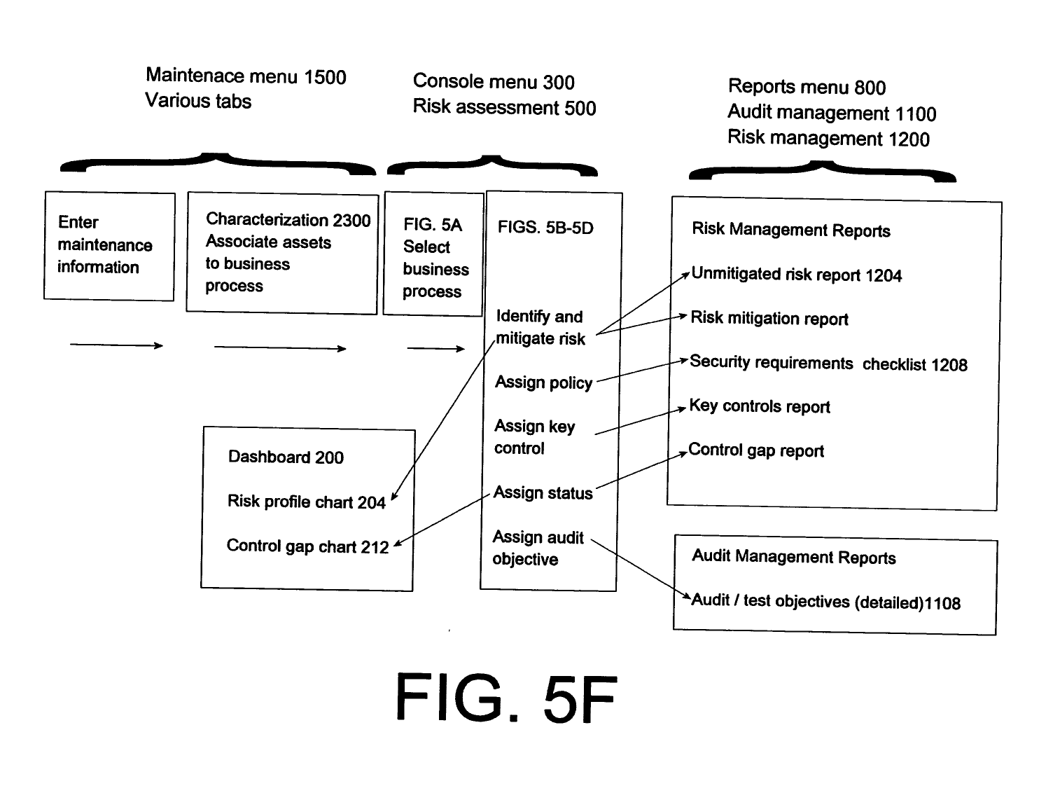

The risk profile 204 represents the cumulative residual risk level of the Client. Residual risk is the level of risk after considering the mitigation strategies (e.g. controls). The chart 204 shows that the exemplary bank has 92 low level risks, with nine risks at a medium level and two at high. The risk data is formatted to be color coded. The larger the percentage of red displayed in the chart, the higher the risk profile of the Client, which should prompt the end-user to give more attention towards developing appropriate mitigating strategies. The residual risk level for a specific risk is changed through the risk assessment tab 512 (FIG. 5C).

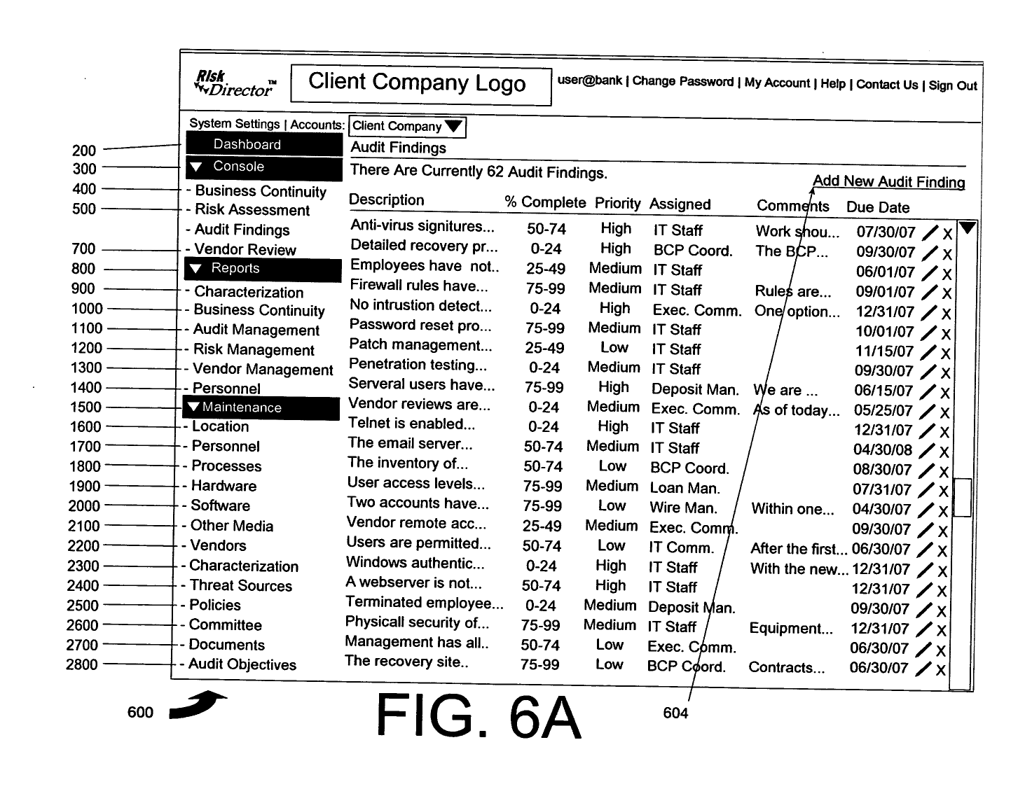

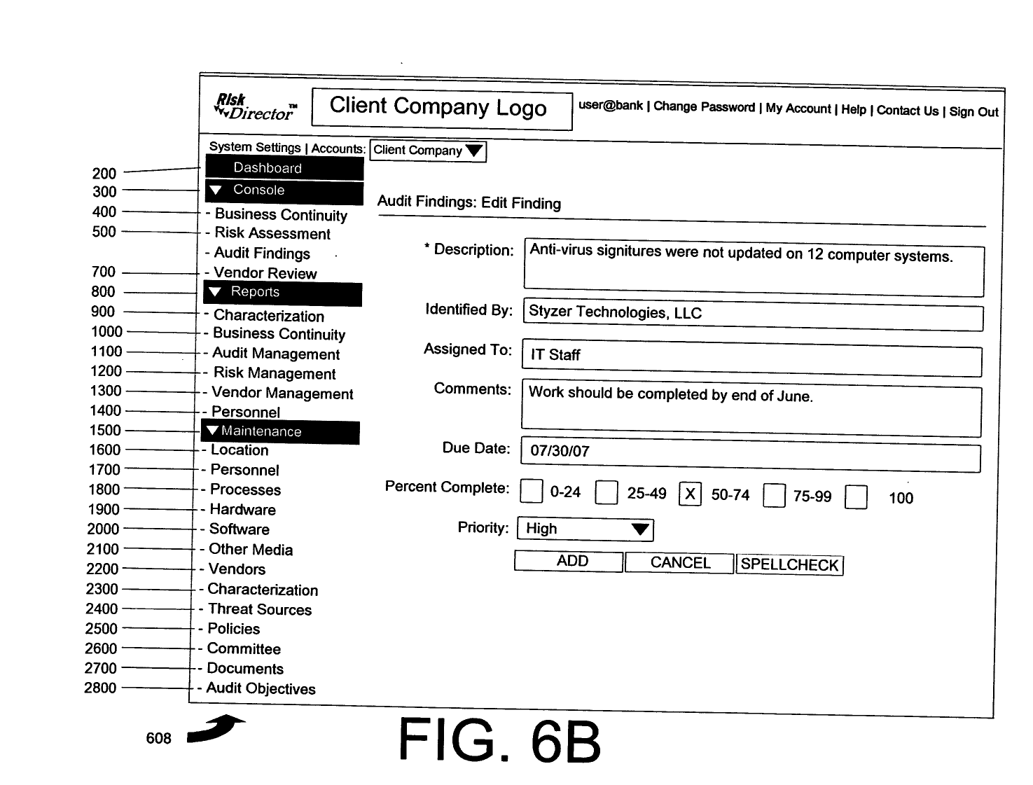

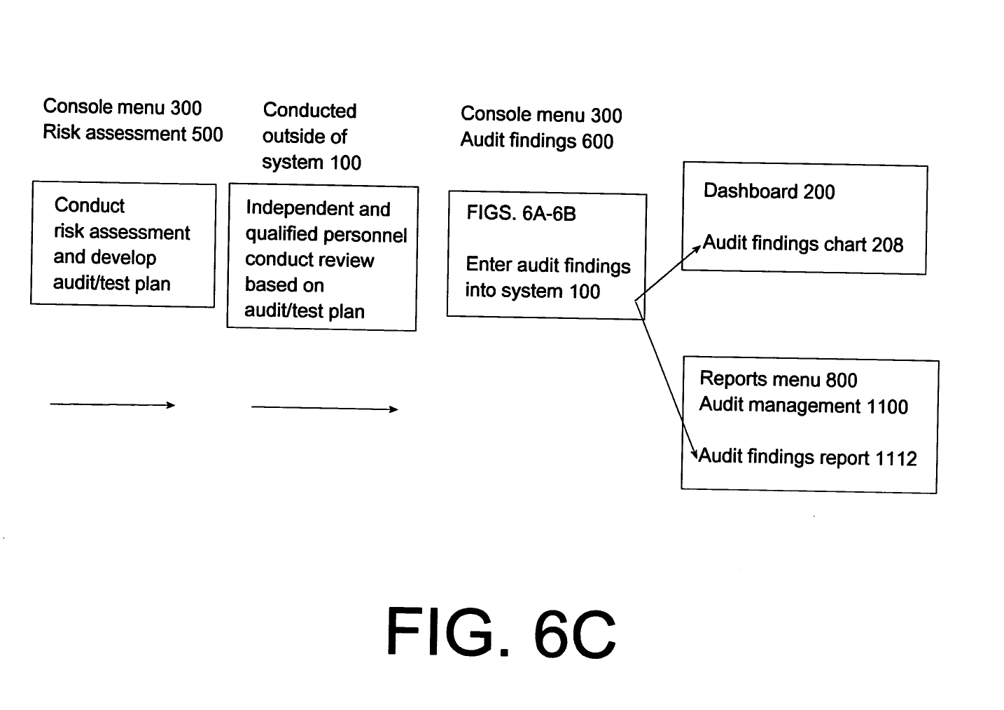

The audit findings chart 208 displays the audit findings, which are reportable items that require corrective action. During the risk identification and mitigation process, the end-user should note whether a mitigation strategy is “in place,” “planned,” or “possible” (FIG. 5D, item 524). Should the mitigation strategy be documented as “in place” but, through an audit or other review, the mitigation strategy was verified to not be in place, such a discrepancy would be documented as an audit finding (FIG. 6B) and displayed in the audit findings chart 208, and the audit findings list 600 (FIG. 6A). Within the audit findings chart 208, these findings are summarized into various severities (such as but not limited to high, medium, low) and the percent of corrective action completed (such as, but not limited to, 0-24, 25-49, 50-74, or 75-99).

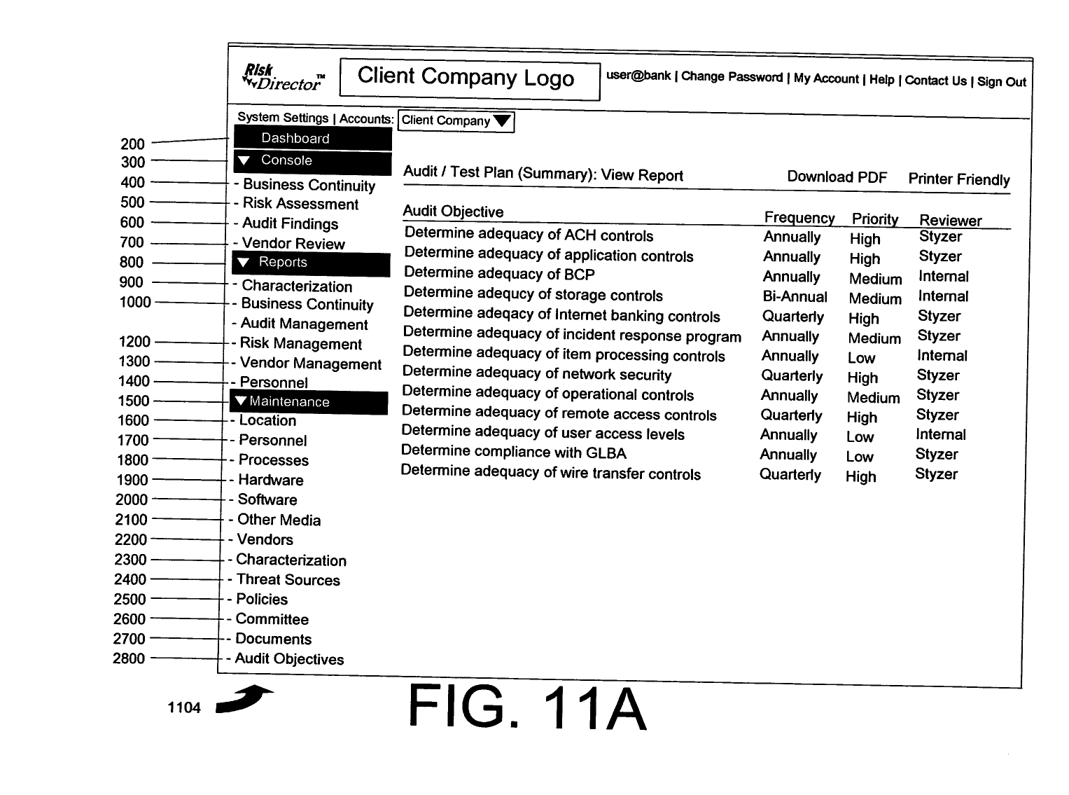

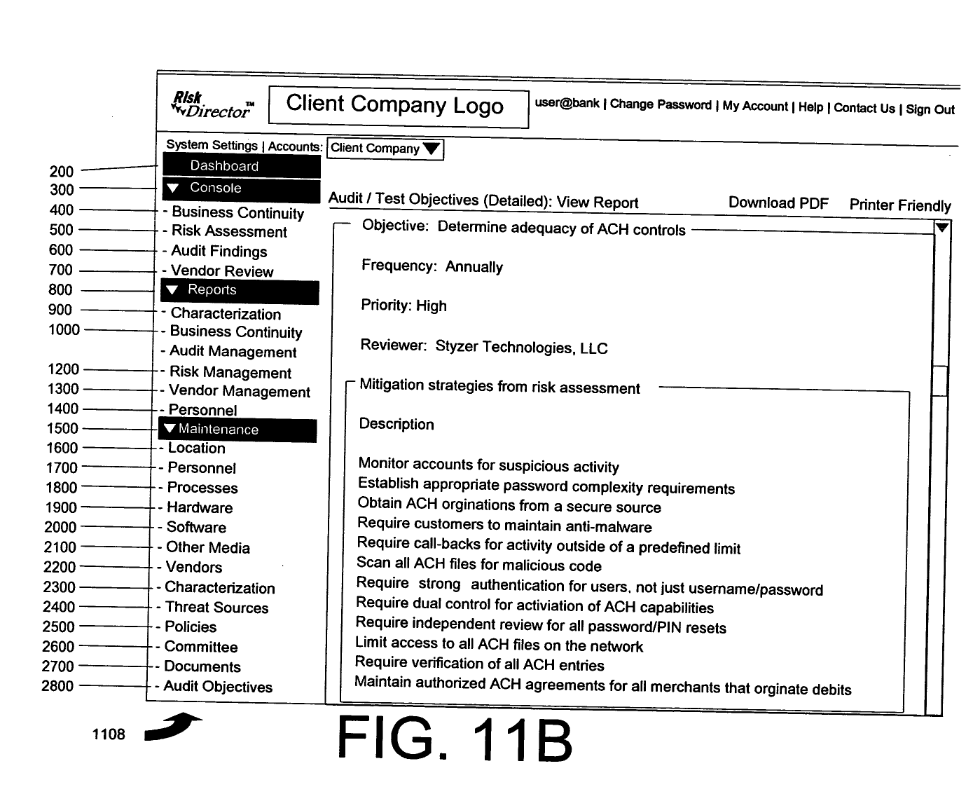

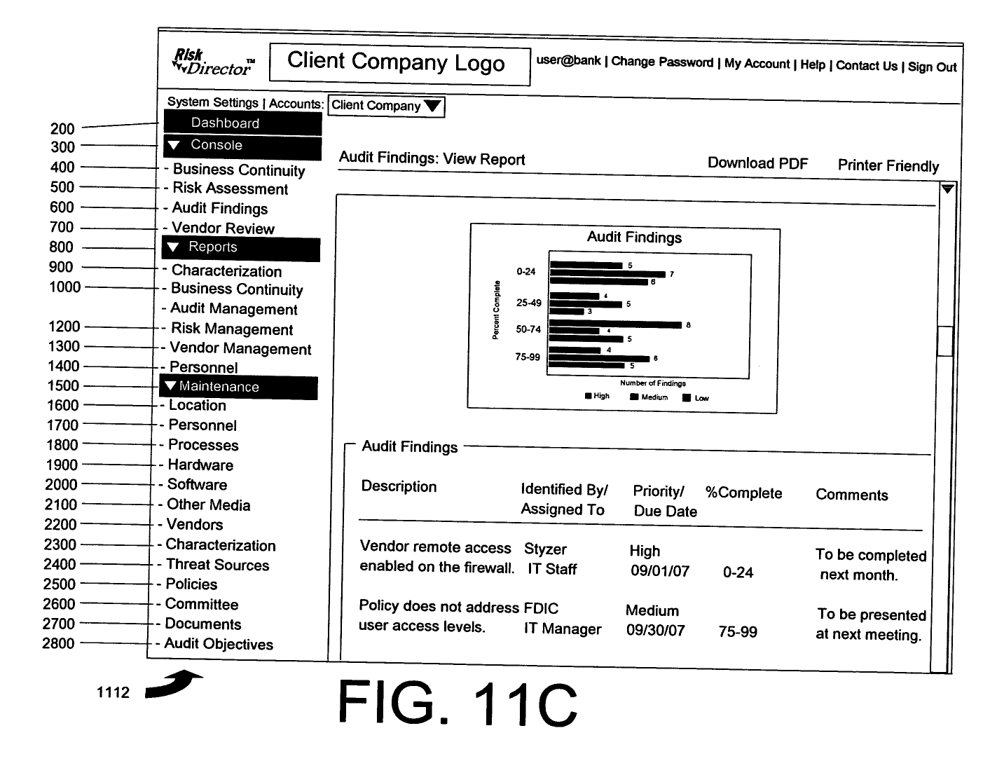

In general, a Client would focus effort on correcting the “high” priority items. As such, these items should be the first to reach the completed status. These color coded bars (high, medium, low) are provided for each of the percentage groups (0-24, 25-49, 50-74, 75-99). If one of the examples shown in FIG. 2 reaches 100 percent complete status, it will no longer be displayed on the dashboard 200. Although displayed as completed, the finding will remain within the audit findings list 600 (FIG. 6A) and the audit findings report 1112 (FIG. 11C), until the user affirmatively deletes it through audit findings tab 600. The Client, including many stakeholders, may find this useful to know about previous problems, and how the Client's operating management addressed such problems. Thus, the Client might want audit findings and documented corrective action to remain for a period of time, such as year end, before deleting the finding completely.

The control gap chart 212 represents planned mitigation strategies, which are those mitigation strategies that were identified during the risk assessment process but have not yet been implemented. This chart assists the end-user in monitoring progress of the mitigation strategy implementation. These mitigation strategies are organized by the various business units or business processes that the mitigation strategy resides, with the process having the most outstanding (or unimplemented) mitigation strategies being listed first.

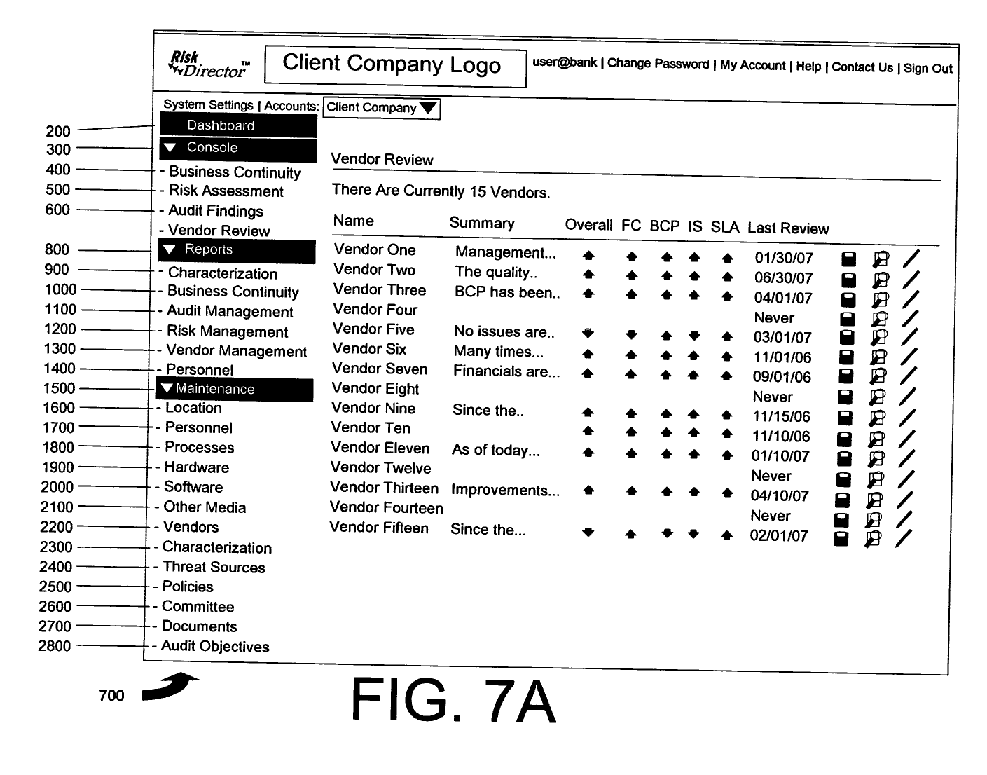

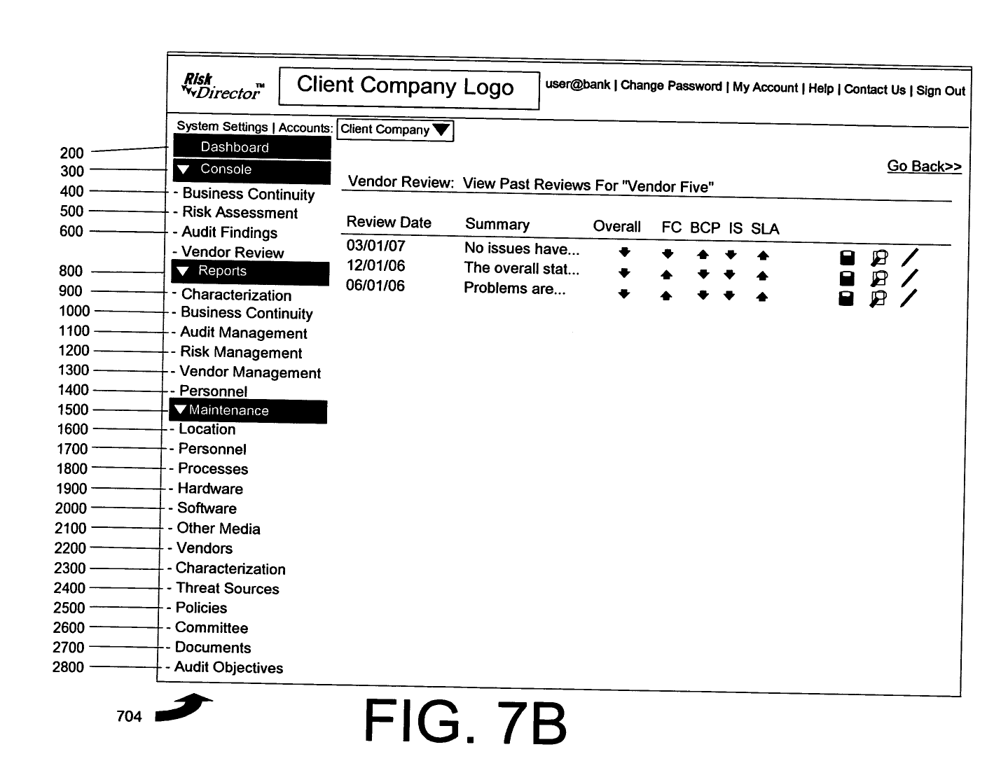

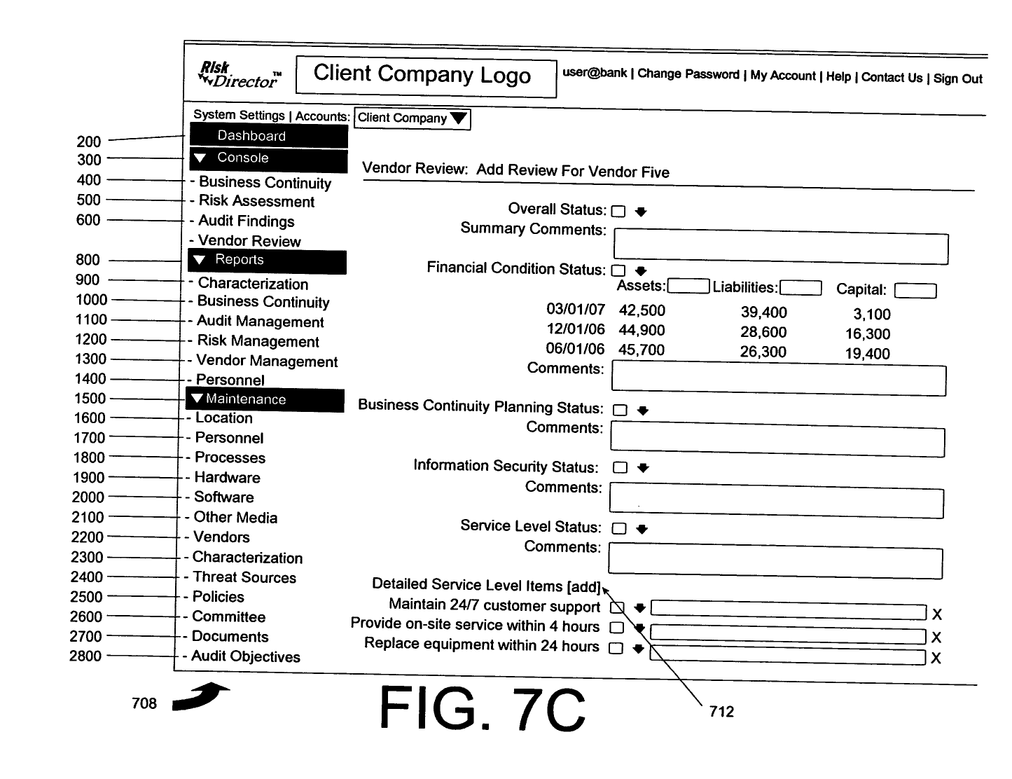

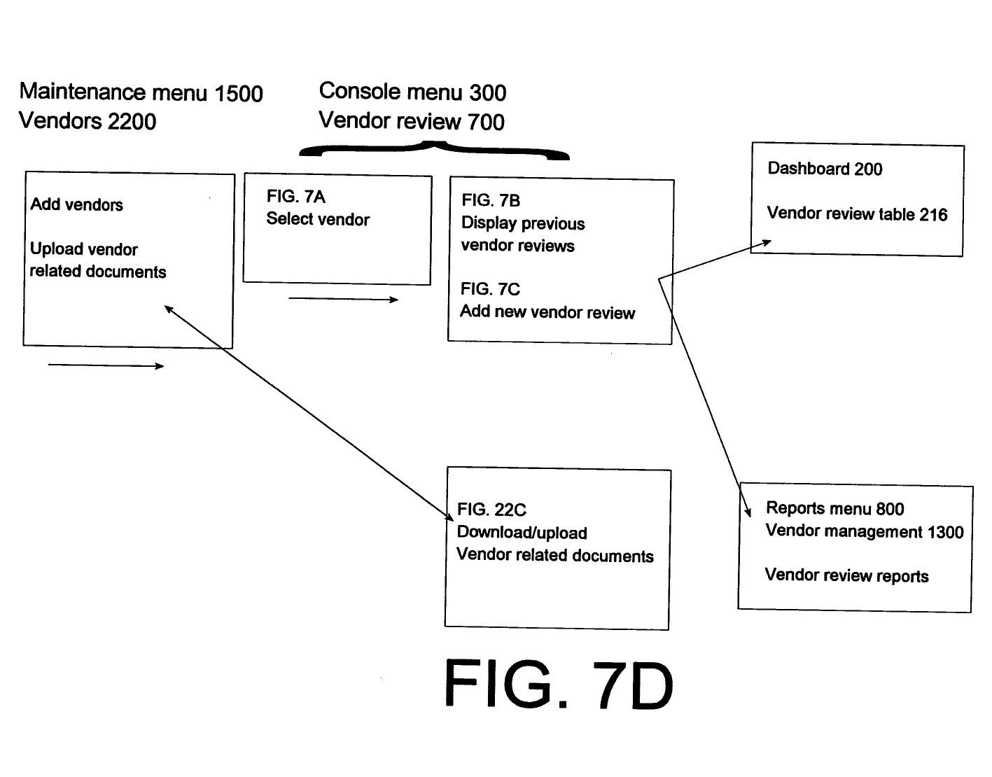

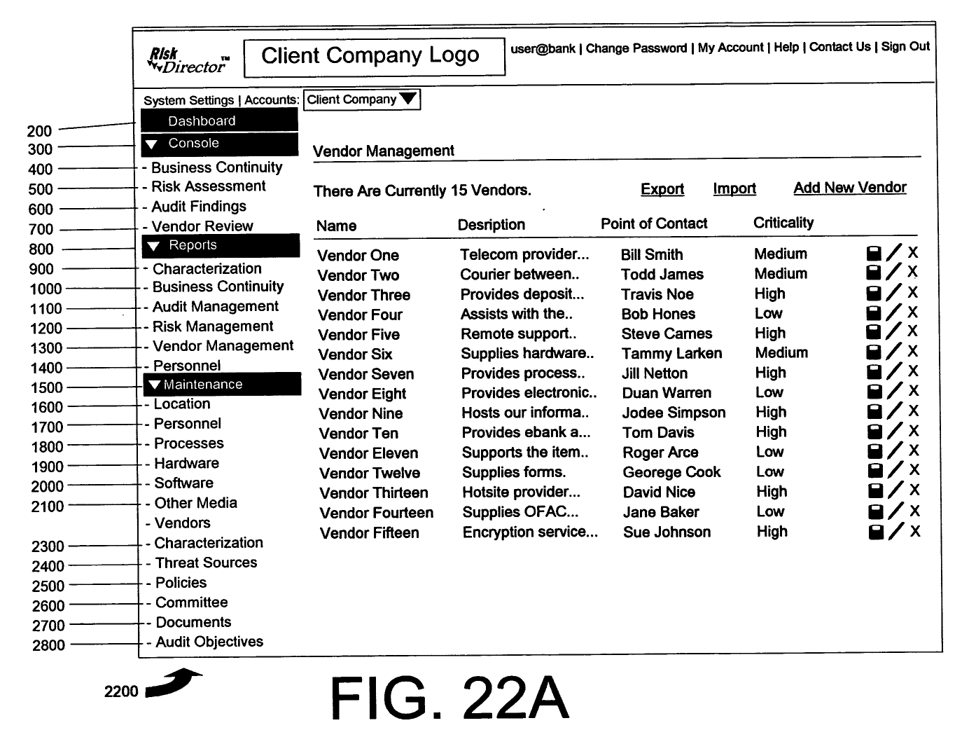

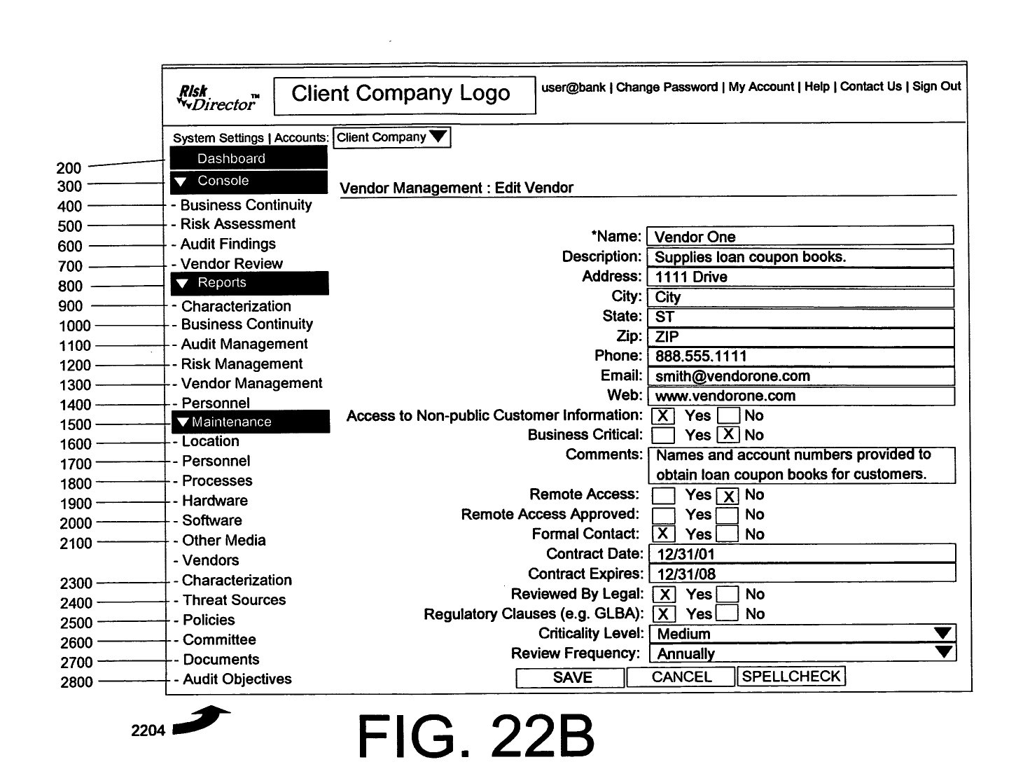

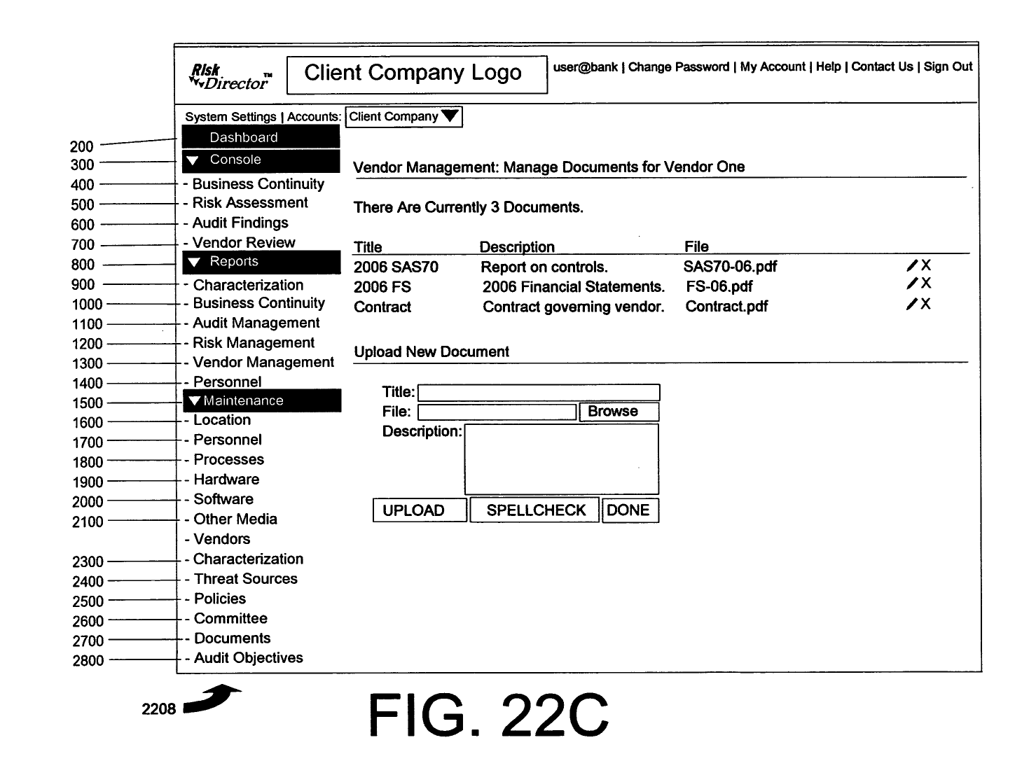

The vendor table 216 displays all of the Client's vendors. This chart provides a quick reference relating to the Client's oversight of critical service providers. The chart indicates the last time a vendor was formally reviewed (e.g. assessment of financial condition) and indicating if that review was successful or unsuccessful. The timeframe for the next review is also displayed and the table is ordered by the next scheduled review. Generally, the timeframe between reviews is one year; however, this timeframe is configurable from the vendors tab 2204 (FIG. 22B). The actual review of the vendor is documented under the vendor review tab 708 (FIG. 7C).

As shown in FIG. 2, as well as many others, the my account feature 220 allows for changes to the Client's account information. This information includes basic items relating to the Client, such as contact information or logo, but also includes other information such as the approved risk tolerance level for identifying “acceptable” risks, and the time periods associated with the various classifications (i.e. critical, vital, essential, and non-essential) used to prioritize business continuity efforts. Meanwhile, the change password feature 224 allows the end-user to change their individual password. The help feature 228 provides access to a comprehensive help document to assist the end-user with using the various aspects of the invention.

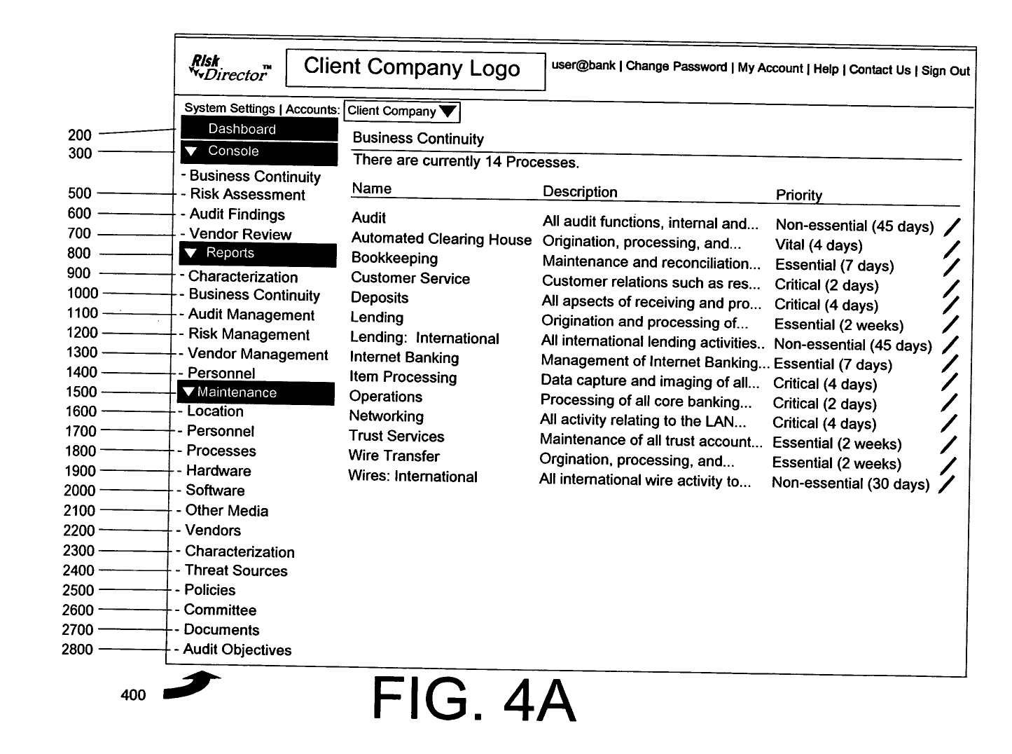

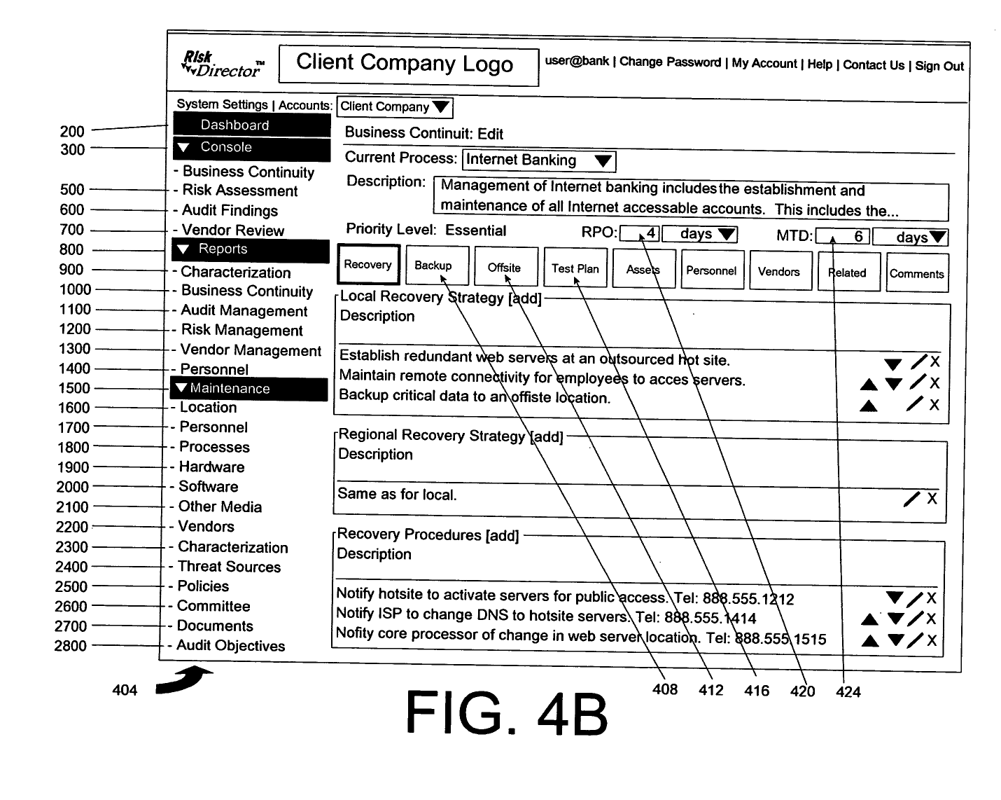

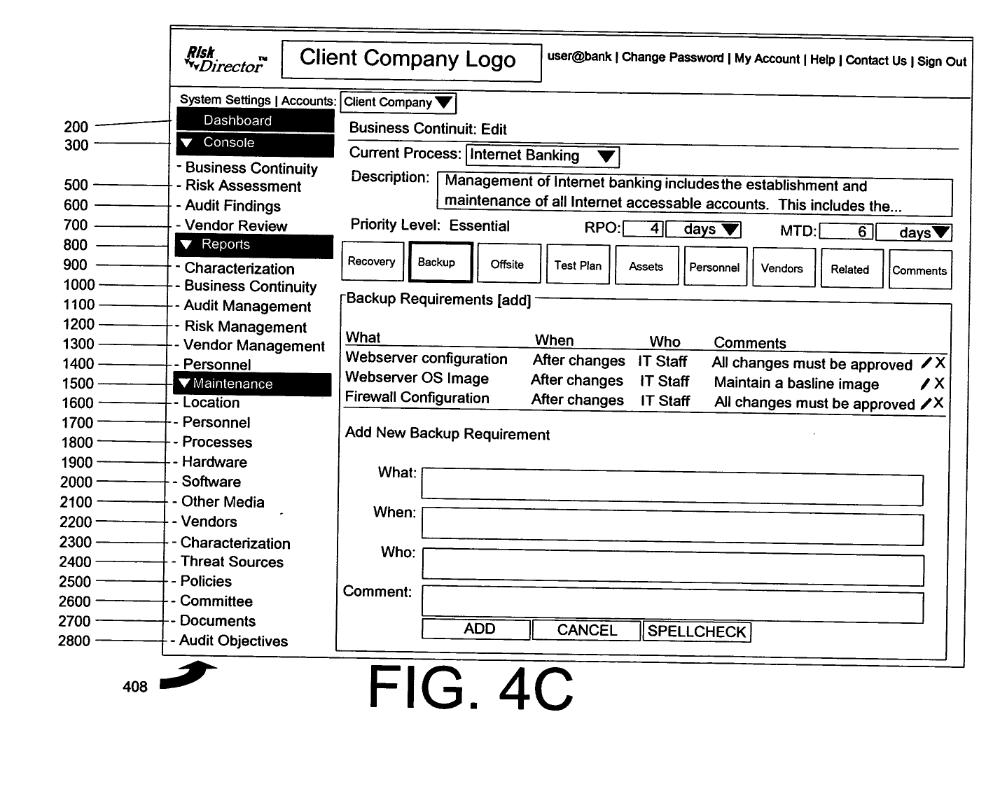

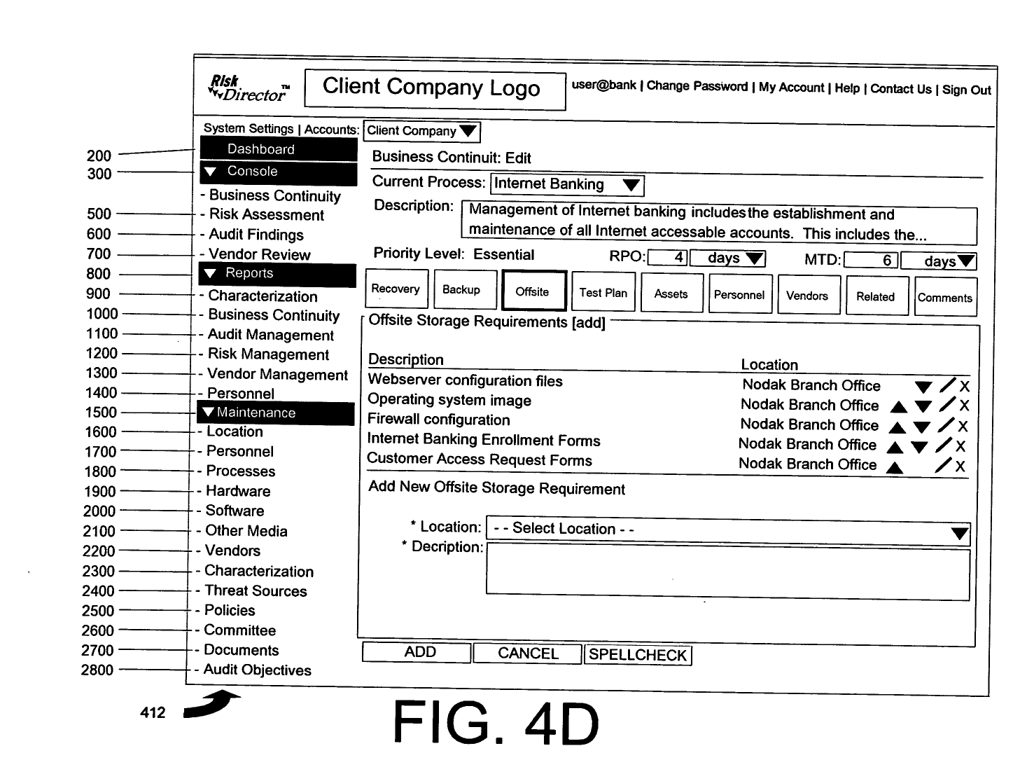

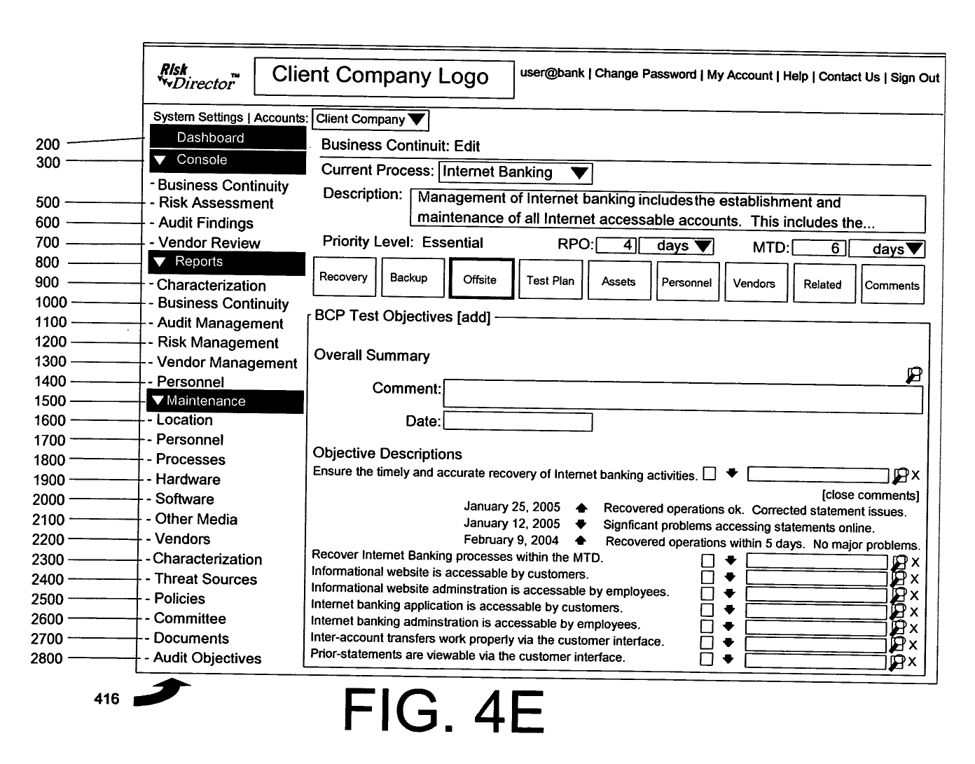

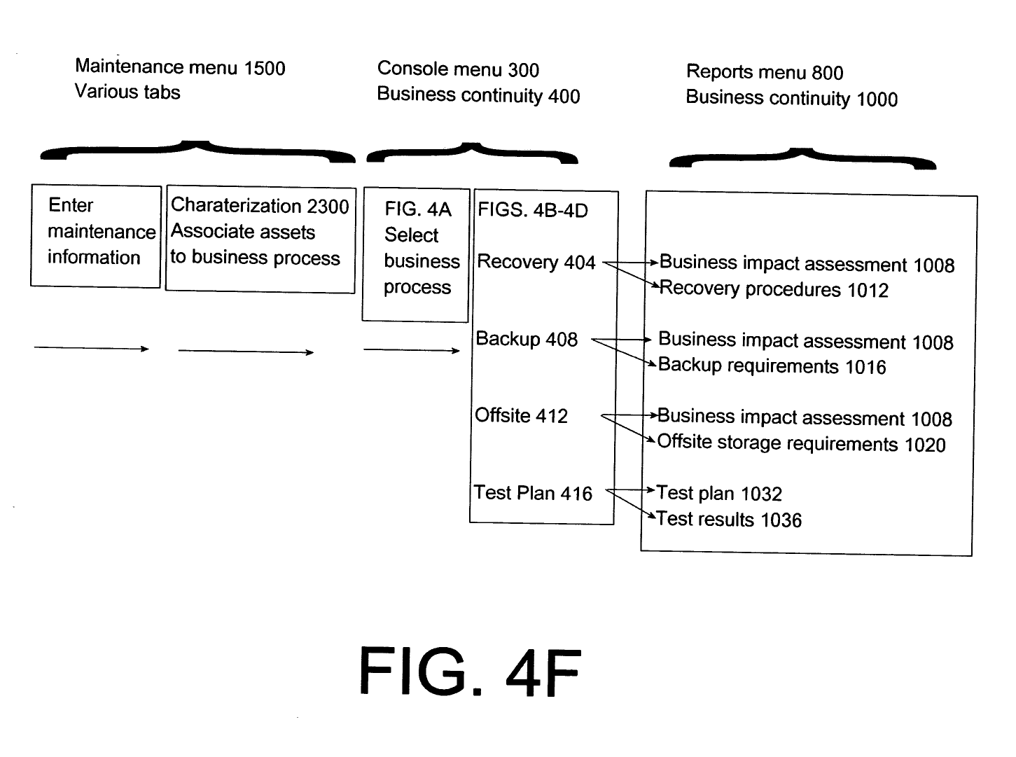

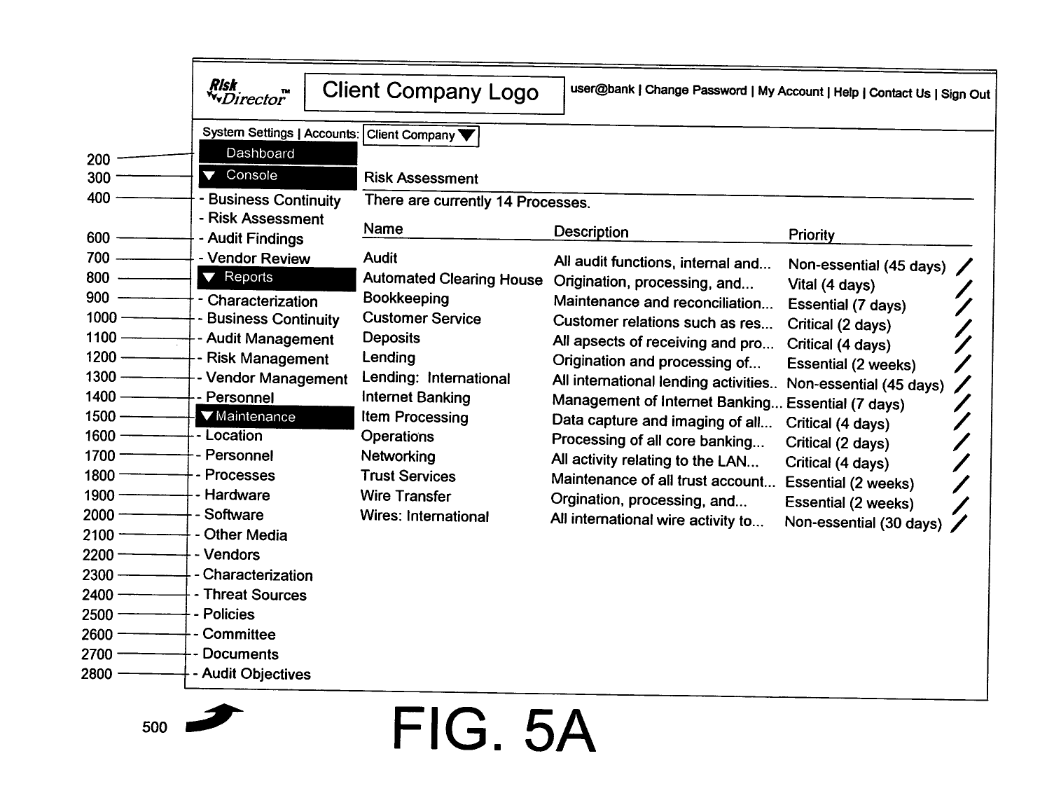

The business continuity tab 400 (FIG. 4A) allows for business continuity planning of each business process established in the maintenance tab 1500. Within the business continuity tab 400, recovery strategies are defined, along with backup and offsite storage requirements (FIGS. 4B-D). In addition, the tab provides the interface for developing a business continuity test plan and documenting the results of any business continuity tests (FIG. 4E). The business continuity reports are provided in the business continuity report tab 1000.

Once the end-user selects a specific business process to edit from FIG. 4A, the end-user is presented with an interface that includes several tabs for entering related information. Above these tabs, all the business continuity edit screens (FIGS. 4B-4F) identify the Client's recovery point objective 420 (RPO) and maximum tolerable downtime 424 (MTD). A Client needs to determine the MTD for each specific business process. The MTD is the time period that a specific business process can be unavailable without impacting the viability of the Client. For instance, a financial institution may determine that it can only operate for seven clays without customers being able to access their accounts via the Internet, without impacting the institution's viability. This suggests that the institution believes that a significant number of customers would withdraw or close their accounts after seven days if the customers are unable to access their accounts online. The recovery strategies, and resulting procedures, should ensure that the business process can be recovered within the MTD. The reason for the unavailability of the business process is irrelevant; an appropriate recovery strategy should be developed. In the above example, the financial institution should be able to recovery their Internet banking process whether the disruption was because a disgruntled employee damaged critical equipment or a natural disaster destroyed the main operating facility.

To facilitate this, the system 100 of the present invention inquires of end-user the MTD for each business process. The time period is determined by the Client and may be in months, weeks, days or hours. The RPO is the time period that a disruption many continue before a decision must be made to implement the recovery strategies. The RPO shown in FIGS. 4B-4F shows that at 2 days, the Client must make a decision regarding any implementation of the business continuity recovery strategies. The RPO is generally the MTD minus the anticipated time needed to implement the recovery strategies. Each business process is also prioritized as critical, vital, essential, or non-essential, based on the MTD. These categories are displayed next to the business processes in pertinent menus and reports throughout the system 100. The time period associated with each category is established in the my accounts 220.

A specific set of icons are shown in FIG. 4B and other Figures, include a pencil, a cross ‘X’, and up and down arrows. However, the icons shown in FIG. 4B are but for exemplary purposes only, so that the present invention should not be considered as limited exclusively thereto. Other icons are also contemplated within the spirit and scope of the present invention.

The pencil icon allows an end-user to access an edit menu. The arrows allow an end-user to sequence any member items within a particular list. If the end-user had multiple items, they could be put in a particular order on the corresponding reports. Aesthetically, such re-ordering looks better and is easier to understand. Meanwhile, the ‘X’ icons perform a delete function. This remains true throughout the entire system 100 of the present invention, and not just in FIG. 4B.

A recovery tab 404 (FIG. 4B) allows the end-user to document specific recovery strategies (local and regional) along with recovery procedures. The recovery strategies are the high-level managerial plans for business continuity. For instance, a financial institution's Internet banking unit may detail strategies that include replicating critical data at another site and establishing a remote connectivity for employees to work from home. The recovery procedures, however, detail the step-by-step guidelines for implementing a recovery strategy. The Client can add as many procedures as necessary. In the above example, the procedures might document the steps needed to change all Internet banking traffic to the alternate data facility. This is just one example of the usefulness of the system 100 in documenting a business continuity plan.

A backup requirements tab 408 (FIG. 4C) identifies computer files that need to be backed up, the frequency of the backups, who is to perform the backups, along with any comments. Archiving of files is needed to facilitate recovery efforts of critical data in the event of a disaster. The backup information is maintained in two business continuity reports (Business Impact Assessment, and Backup Requirements Listing), which are accessed through the business continuity tab 1000.

The offsite requirements tab 412 (FIG. 4D) identifies what items the Client needs to store offsite for business continuity purposes. This tab also documents the location of the offsite storage. The offsite storage requirements would likely include the information detailed in the backup listing, but would also include non-computer related items such as specific forms, office supplies, medical supplies, and other related items. These offsite storage items are critical to the recovery efforts should the primary operating location be unavailable. Like the backup information, the offsite storage information is maintained in two business continuity reports (Business Impact Assessment, and Offsite Requirements Listing), which are accessed through the business continuity tab 1000.

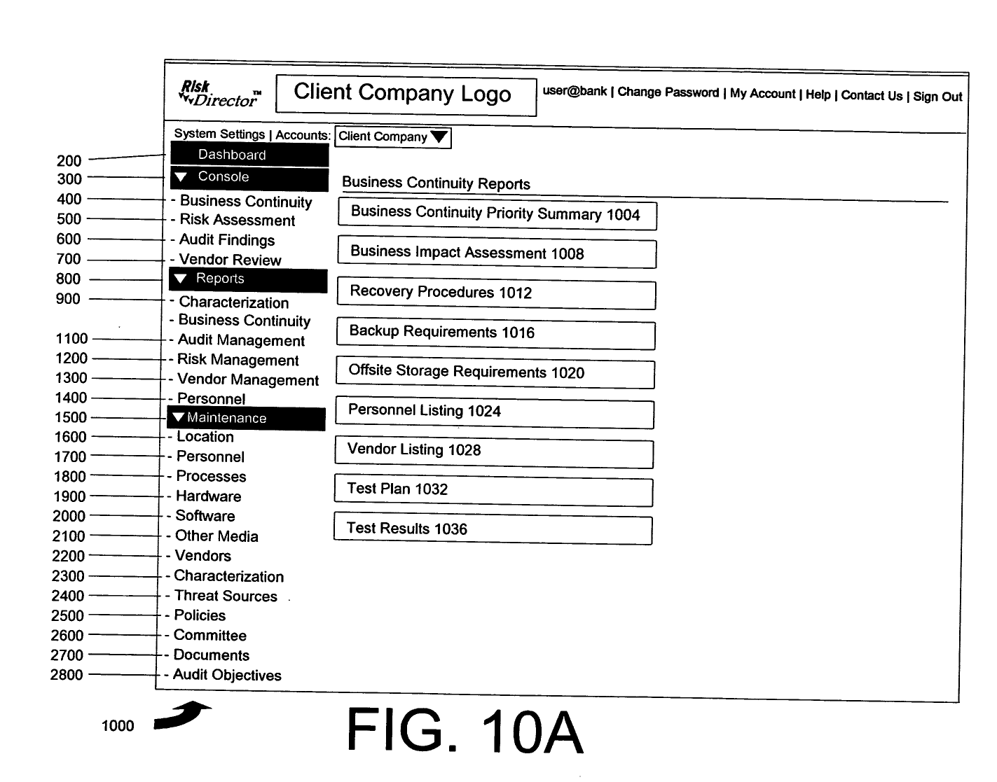

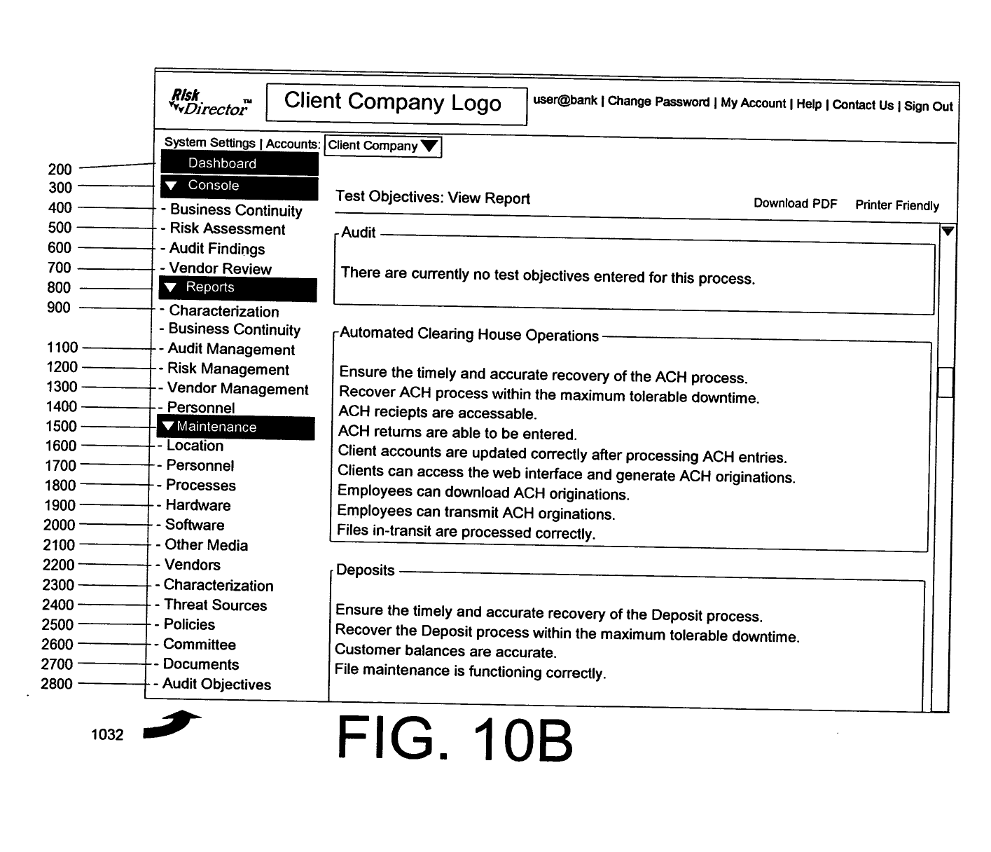

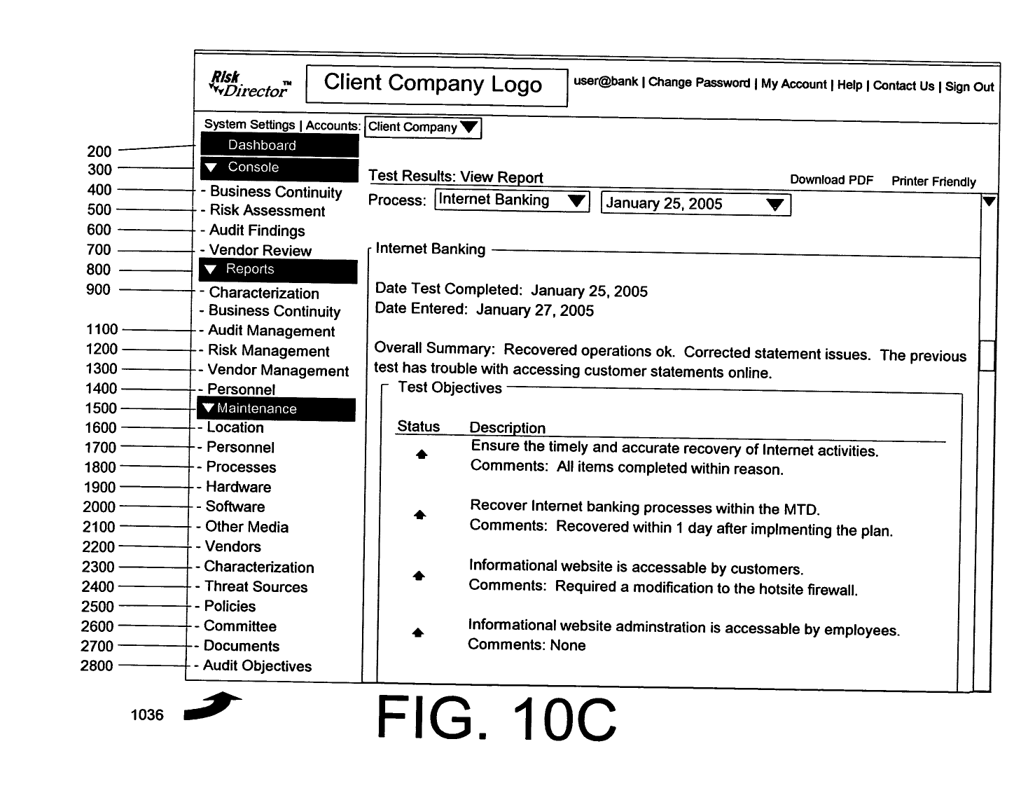

A business continuity plan should be tested to ensure that it is adequate to recover operations in the event of a disruption. The present invention also allows a Client to document a business continuity test plan by entering test objectives in the test plan tab 416 (FIG. 4E). These objectives detail the business functions (within a business process) a Client determines should be operational after any successful recovery efforts. When a Client conducts a business continuity test, the test objectives documented in the test plan will provide criteria to determine if the test was successful. During the test, the Client should follow the recovery procedures outlined in the business continuity plan. After completing the test, the Client then determines if the previously established test objectives were achieved. For instance, a financial institution may establish one test objective that states, “Customers' deposit account balances were available and accurate.” After restoring from backup at an alternate facility, the institution would document whether they achieved this objected by following their current business continuity plan. Consequently, if a Client conducts a test and various objectives pass, but others fail, such an aberration will be documented through business continuity test plan tab 416 (FIG. 4E) and be shown on the business continuity test report 1036 (FIG. 10C). This aberration would prompt the end-user to revaluate the plan, recovery strategies, and recovery procedures, and/or the test objectives. The test should be repeated until the entire business continuity plan is considered successful.

When entering the test results, the end-user can review the results of previous tests for each test objective by selecting the icon next to the appropriate objective. This feature helps the end-user identify any trends within the various objectives, as shown in FIG. 4E. In addition, all previous test results are available through the business continuity tab 1000.

FIG. 4F depicts how the business continuity tasks performed through the business continuity tab 400 relate to other component of system 100, such as reporting capabilities and the maintenance section.

The risk assessment feature of system 100, discussed in detail in the next section, allows the end-user to document risks to the confidentiality, availability, and integrity, of business processes, and develop mitigating strategies to reduce identified risks. In relation to business continuity, any risks to the availability of a business process would be considered. For instance, if a financial institution has an outsourced recovery facility that maintains completely redundant systems for its Internet banking unit, the bank has a recovery strategy in place to ensure Internet banking is available regardless of a specific event (e.g. tornado). However, there is commonly an “activation” fee to occupy such a recovery facility.

Continuing the example, now suppose the institution experienced power loss several times throughout the year that exceeded the institution's RPO. In order to be operational within the MTD, the decision was made to activate the recovery site. Each time the site was activated, the institution was charged thousands of dollars. To reduce the risks posed by a loss of electrical power, the institution invested in an electrical power generator. This mitigation strategy lowered the probability of future activation charges, more than offsetting the cost of the generator, by preventing the need to activate the recovery site due to a loss of electrical power. However, the institution still maintains the redundant recovery facility in case of other events that may cause a disruption (e.g. tornado).

The risk assessment tab 500 (FIG. 5A) is where the risk assessment tasks, such as documenting specific risks and associated mitigation strategies, are conducted. Like the business continuity tab, all risks and associated mitigation strategies are organized by the business processes established in the maintenance menu 1500. Similarly, the risk management reports are provided in the risk management tab 1200.

The identification and documentation of risk should be the foundation of a Client's control environment. Through the risk assessment tab 500, the invention allows the end-user to identify and mitigate risk and document the Client's control environment.

The end-user accesses the specific risks assigned to a business process through the risk assessment menu 500 (FIG. 5A). Once a business process is selected, the end-user will be presented with a list of risks associated with that process (FIG. 5B). The list will contain the risk that the end-user identified; including the risk level before mitigation, the residual risk after considering the mitigation strategies, the probability of occurrence, and the impact should the risk be exploited. These items are subjective and the determination of each value is reliant upon input from the end-user. The level of effort used to substantiate the assigned values will vary from Client to Client.

With the proper access level granted (e.g. Manager or Client with authorization), the end-user can populate this table with risks and recommended mitigation strategies and other related attributes by selecting the add risk from predefined list link 508 (FIG. 5B). This action will present the end-user with a list of risks 528 (FIG. 5E), that if selected, would then be incorporated into the Client's risk assessment for that specific business process.

From the edit screen 512 (FIGS. 5C-5D), the end-user can edit the various attributes (e.g. description, risk type, probability) associated with the risk. FIGS. 5C-5D show mitigating strategies that the end-user has decided to employ to reduce the residual risk to an acceptable level. In one example, the management of a financial institution has decided that a firewall will be installed to prohibit unnecessary activity to their web server that is used for Internet banking. The present invention also allows the end-user to identify the status of the mitigation strategy, assign the audit objective that will validate the mitigations status, designate a written policy that will implement the mitigation strategy, and identify whether the control is outsourced to a third party. The end-user can, and should, assign a these items for every mitigation strategy documented in the risk assessment.

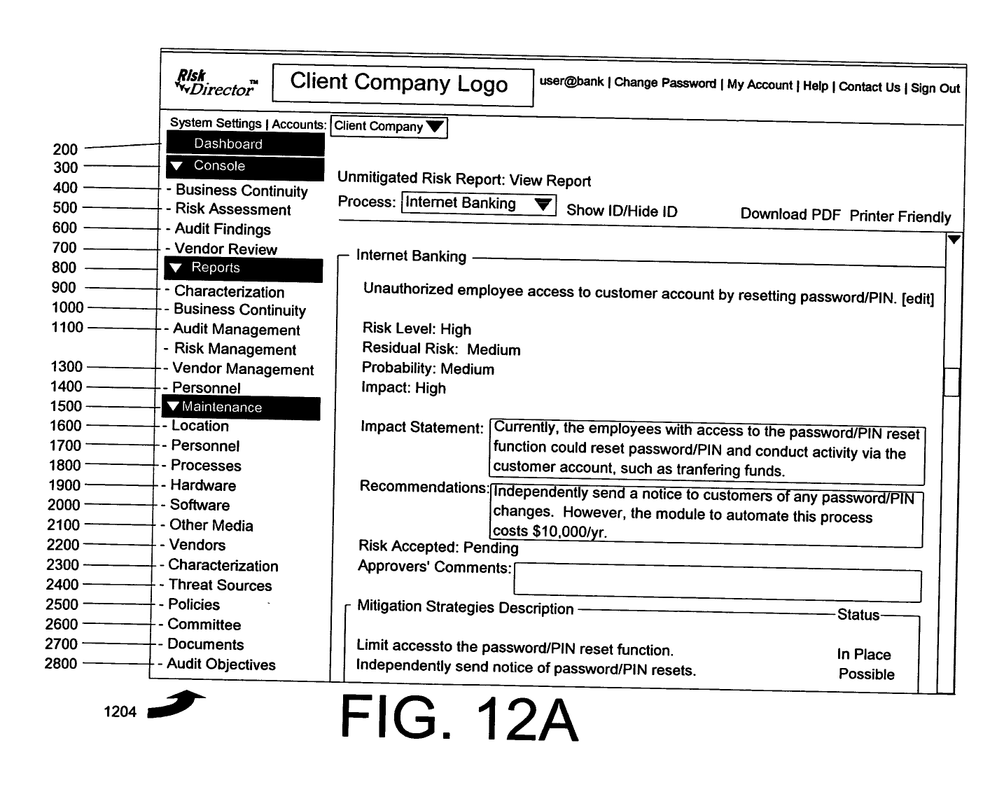

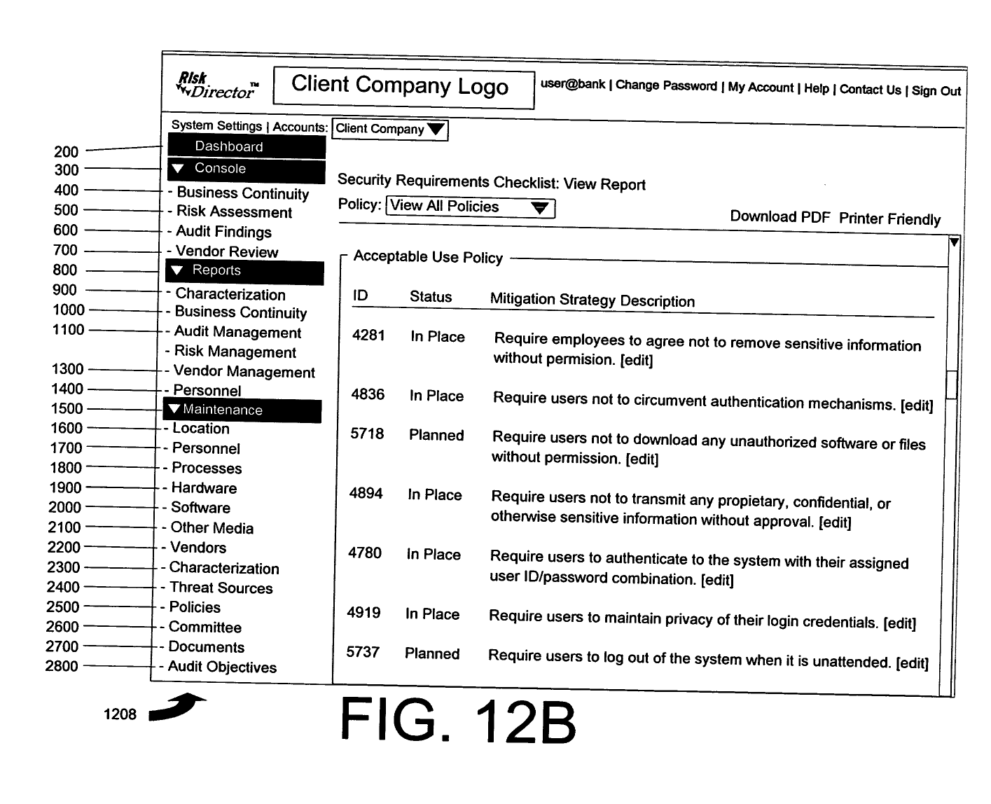

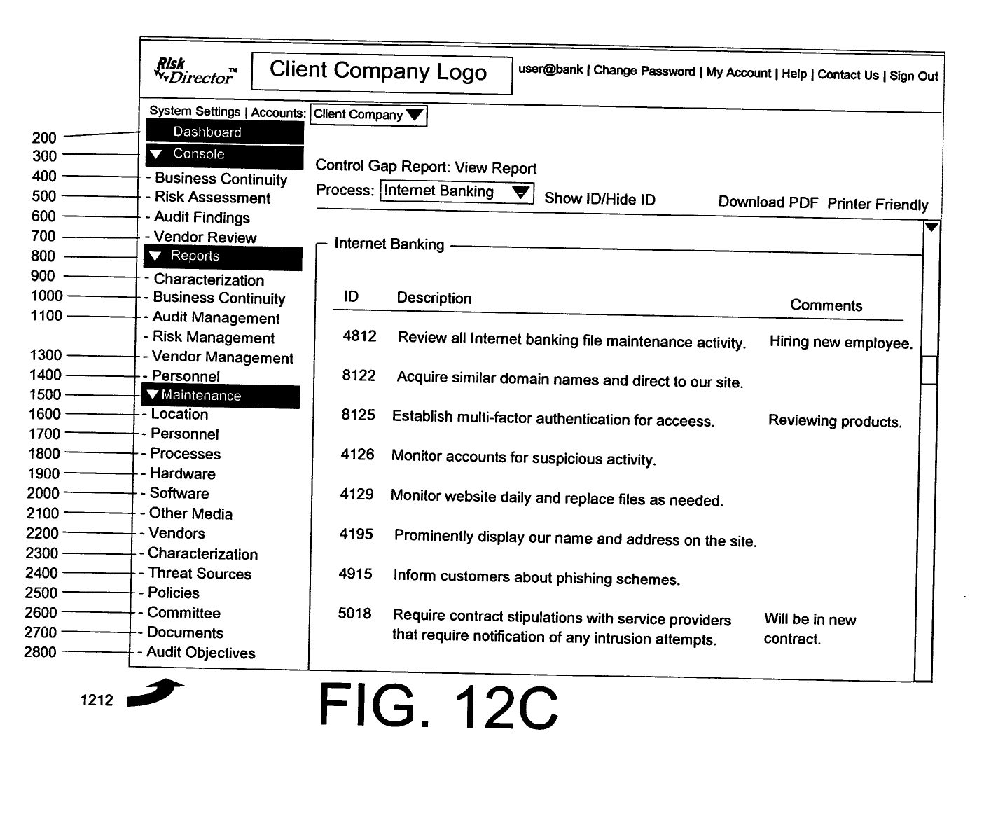

All risks with a residual risk level that exceeds the approved risk tolerance level (established in the my account 220) will be included in an unmitigated risk report 1204 (FIG. 12A). The Client should report unmitigated risks to appropriate personnel, such as the board of directors, for their acceptance of the risk or their requirements for additional mitigation. The system 100 requires that the end-user input a statement describing the impact any unmitigated risk. If the end-user attempts to save the information without a statement, the system 100 states, “you've exceeded the risk tolerance” and subsequently requires an impact statement, without which the user cannot advance to the next screen or menu. This statement is optional for risks that are below the approved risk tolerance level. The end-user also has the option to document any recommendations relating to the risk. These statements help the approving personnel evaluate any risk acceptance decisions.

Generally, the Client has significant latitude when determining the level of risk that they are willing to accept. However, in some regulated industries, the acceptance of specific risks may be prohibited. The system 100 allows the Client to evaluate risk management decisions for those risks that are within their discretion. In general, risks that exceed the tolerance level require additional resources (time, personnel, equipment, etc . . . ) that Client does not currently have at their disposal. For instance, a common control for mitigating the risk of an employee initiating an unauthorized wire transfer at a financial institution is to have the wire transfer system force all transactions to be verified by another person. At some smaller financial institutions, the risk may not outweigh the cost of hiring additional personnel to appropriately segregate the duties. As indicated earlier, appropriate personnel within the Client company should be notified of any unmitigated risks. As shown in FIG. 5C, the system 100 identifies unmitigated risk as “pending” until a risk acceptance decision has been made. If the risk is accepted there is no change to the control environment.

If the approving party refuses to accept the risk, they should direct Client management to take further action. The additional requirements would then be documented in the comment field 520 (FIG. 5C). In the example given above, if the approving party mandates that additional staff be hired to mitigate the risk to an acceptable level, the mitigation strategy would be considered “planned” (i.e. unimplemented) and would be included on the control gap report 1212 (FIG. 12C) and the corresponding control gap chart 212.

FIG. 5F depicts how the risk management tasks performed through the risk assessment tab 500 relate to other component of system 100, such as reporting capabilities and the maintenance section.

The audit findings tab 600 (FIG. 6A) is used to document audit findings, which may include findings from multiple sources, such as internal staff, external audit or consulting firms, and regulatory agencies. The summary of these findings can be viewed on the dashboard 200 or the detailed results can be viewed through the audit findings report 1112 (FIG. 11C).

As indicated earlier, a Client should validate that mitigation strategies documented during the risk assessment are in place and working as intended. This review should be review conducted by independent and qualified personnel with the scope of the review based on the audit objectives (i.e. audit plan) derived from the risk assessment. If any of the mitigation strategies are not in place or are not provided the intended risk reduction, the discrepancy would become an audit finding that requires corrective action. The end-user has the option to track this information within system 100.

To enter a new audit finding, the end-user would select the add new audit finding link 604 (FIG. 6A) and enter the appropriate information in edit menu 608 (FIG. 6B). The end-user would provide a description of the finding, the identifying party, the responsible party for implementing corrective action, the due date for corrective action, and the priority of the finding. The percent progress towards corrective action is also tracked, with the default set at 0-24 percent, which is likely the percentage at the time the finding was identified. The end-user has the option to add comments, such as what actions will be taken to correct the deficiency. Once entered, the finding would be displayed in several areas within the invention, such as the audit listing 600 (FIG. 6A), audit findings report 1112 (FIG. 11C) and summarized on the audit findings chart 208 (FIG. 2).

The end-user can modify an audit finding by selecting the desired item from the audit findings list 600 (FIG. 6A). The end-user would be presented with the same edit menu used to add a new finding (FIG. 6B), but the fields would be populated with the relevant data. This interface allows the end-user to modify the pertinent information, such as the percent complete, or add comments relating to any corrective action that is being undertaken.

As indicated earlier, once the corrective action for a specific audit finding reaches 100 percent complete, it will not be displayed in the audit finding chart 208, but will remain in the system 100 to be available for the other audit reporting capabilities of the present invention. Deleting an audit finding is accomplished by selecting the crossed ‘X’ from the audit findings list 600 (FIG. 6A).

FIG. 6C depicts how the audit tasks performed through the audit findings tab 500 relate to other component of system 100, such as reporting capabilities and the risk assessment section.

As part of a comprehensive risk management framework, Clients should ensure that the framework extends to govern outside entities that provide products or services that are critical to the operation of the Client's business. To ensure that vendors continue to provide adequate and secure products or services, the Client should conduct ongoing due diligence for appropriate vendors. The vendor review tab 700 (FIG. 7A) allows a Client to document their oversight of critical vendor. The oversight of critical vendors should include reviewing the vendor's financial stability, the vendor's business continuity plans governing the vendor's ability to provide products or services in the event of a disaster, the vendor's control environment governing the any sensitive data of the Clients that they may have access to, and the vendor's historical service performance. The vendor review feature of system 100 allows the Client to document the aforementioned items on an ongoing basis. The system 100 even reminds the end-user of the next upcoming review by listing it on the dashboard vendor table 216.

As shown in FIG. 7A, the end-user can view all the Client's vendors by selecting the vendor review tab 700. This menu allows provides a summary comment of the last review, along with an arrow indicating if each individual review component (i.e. financial condition, business continuity, information security, service level performance) was successful or unsuccessful. From the same menu, the end-user can select a particular vendor and view the previous reviews for that vendor, as indicated in FIG. 7B. From that menu, the end-user can select a specific review to see the full details. The end-user can also see previous reviews by accessing the vendor reports provided in vendor management tab 1300.

The end-user creates a new vendor review by selecting the icon associated with the appropriate vendor from the listing 700 (FIG. 7A). Once selected, the end-user will complete the pertinent components displayed in the vendor review interface 708 (FIG. 7C). The system 100 facilitates vendor oversight by providing clickable arrows to indicate the status of each component as successful or unsuccessful and providing the option to add any specific comments. The level of detail documented in each comment section will vary from Client to Client. The criticality and type of products or services provided by the vendor will also be a factor in determining the level of detail to include. The end-user can select the icon adjacent to each component to view all the previous comments for each area, such as information security controls. This allows the end-user to easily view a historical trend for a particular component.

The detailed service level review items 712 (FIG. 7C) allows the end-user to add specific criteria that will be evaluated for a vendor. For example, a particular Client vendor may be under contract to provide 99 percent uptime for the hosting of a web server. The detailed service level review items 712 allows the end-user to add this specific item as a requirement to be reviewed, which includes indicating if the vendor achieved that requirement. The actual determination of compliance in not completed by the system 100, but the end-user of system 100. For instance, an end-user may review computer logs to verify the uptime in the aforementioned example. However, the Client management would decide whether such a step was necessary to determine compliance. It is possible that Clients may not use all of the capabilities of the system 100 of the present invention, but the functionally is available.

The end-user may also upload supporting documents associated with a particular vendor. These documents may include such items as the vendor's financial statements, business continuity test results, audit reports, or governing contracts. The end-user may upload these documents into the system 100 by selecting the diskette icon next to the desired vendor, which will then display the document upload menu 2208 (FIG. 22C) located in the maintenance section 1500.

FIG. 7D depicts how the vendor oversight tasks performed through the vendor review tab 700 relate to other component of system 100, such as reporting capabilities and the maintenance menu.

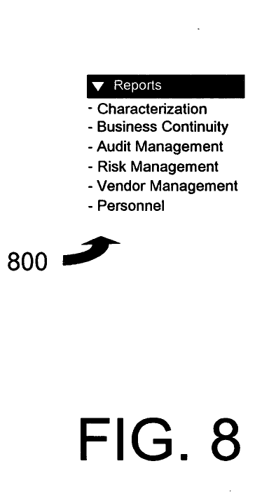

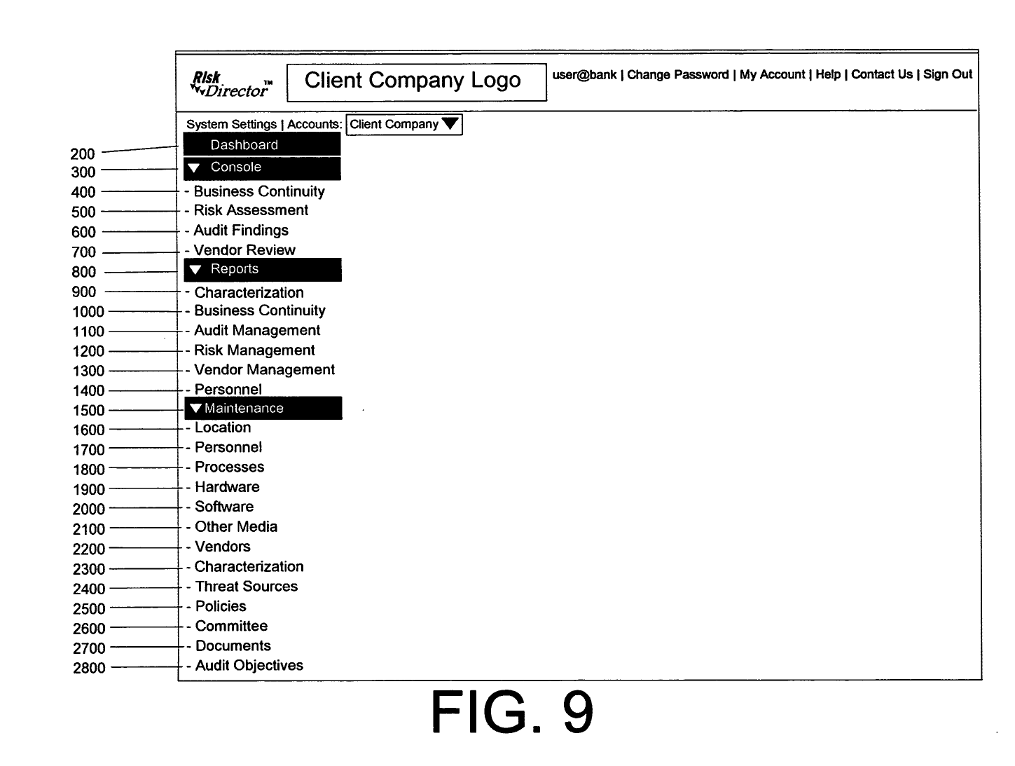

The reports menu 800 (FIG. 8) provides various report capabilities used within the system 100 of the present invention. In general, the reports are organized by the same categories as the console section. Many of the report contents can be displayed in various views. For instance, the audit objectives detailed in the audit/test plan (summary) report 1104 (FIG. 11A) can be ordered (ascending/descending) by the various column headings within the report. This functionality is the case for all reports that are not ordered manually. Another option, available for reports that are organized by business process, is the ability to limit the report to one or all business processes. For date related reports, such as vendor reviews or business continuity test results, the end-user may limit the report to a specific date. The ability to narrow the scope of a report is not limited to the aforementioned examples. The reporting capabilities of system 100 should not be limited to the specific reports detailed herein, as other reports are envisioned, such as inventory listings of hardware and software.

The characterization report tab 900 details the association between specific business processes and specific information assets such as hardware, software, personnel, and vendors. This association helps ensure that that all critical information assets are considered and not accidentally overlooked during the risk management process, such as when assessing risk, conducting business continuity planning, or providing oversight of critical vendors. Characterization of systems is a generally recognized first step in the risk management process as detailed in the National Institute of Standards and Technology's Special Publication 800-30 Risk Management Guide for Information Technology Systems.

The business continuity tab 1000 (FIG. 10A) provides access to several business continuity related reports. Business continuity connotes what a Client will do if there is a disruption of a business process, such as if the Client cannot operate from their main facility, or some other hindering circumstance. It is important within many industries to have appropriate continuity plans in case of some kind of disruption, albeit manmade events or natural disasters, such as earthquakes or tornadoes. As indicated earlier, a Client should have a business continuity plan regardless of any specific risks.

The business continuity priority summary report tab 1004 (FIG. 10A) documents the RPO and MTD for each business process. Generally, an appropriate party, such as the Client's board of directors, should approve these timeframes. These timeframes are the basis for the recovery strategies that will be employed when a disruption occurs at a Client's operating facility (resulting in activation of the business continuity plan).

The system 100 provides a Client with reports detailing important business continuity related items for each of the Client's business processes. The business impact assessment report 1008 (FIG. 10A) identifies the RPO, MTD, and the associated recovery strategies, backup requirements, offsite storage requirements, along with the supporting hardware, software, personnel, and vendors for each business process. Any comments or descriptions provided in the business continuity tab 400 are also included. This report does not take into account risks to the “availability” of business processes as these risks are identified in the risk assessment reports. The report is organized by business process. As a result, the end-user may view all business processes, or limit the report to a specific one.

Recover procedures report tab 1012 (FIG. 10A, report not shown) details the recovery procedures that were entered into the business continuity tab 400. As stated earlier, the recovery strategies are the step-by-step guidelines for implementing the documented recovery strategies. The report is organized by business process. As a result, the end-user may view all recovery procedures, or limit the report to a specific business process.

The backup requirements report tab 1016 (FIG. 10A) details the computer files that were identified in the business continuity tab 400 that need to be available in order to restore a business process in the event of a disruption. The report documents what files are to be backed up, the frequency that the files will be backed up, and who is responsible for performing the backups, along with any comments. The report is organized by business process. As a result, the end-user may view all backup requirements, or limit the report to a specific business process. This report helps the Client monitor that critical files have been identified for backup. The backup requirement listing is also a component of the business impact assessment.

The offsite storage requirements report tab 1020 (FIG. 10A, report not shown) details pertinent items, such as computer files, documents, supplies, that need to be available in order to restore a business process in the event of a disruption. As there may be multiple offsite storage locations, the report identifies the location of each item. The report is organized by business process. As a result, the end-user may view all offsite storage requirements, or limit the report to a specific business process. This report helps the Client inventory needed items that must be stored offsite so that the items are available in the event of a disruption, such as from a hurricane or tornado. The offsite storage requirement listing is also included a component of the business impact assessment.

A personnel listing report tab 1024 (FIG. 10A) is available from the business continuity report section. The report, arranged in alphabetical order, contains a listing of Client personnel. The report includes the contact information for each person identified. This report is beneficial for contacting Client personnel, such as after a disaster. For this reason, it is included within the business continuity tab. However, the same report is available directly from the personnel listing tab 1400.

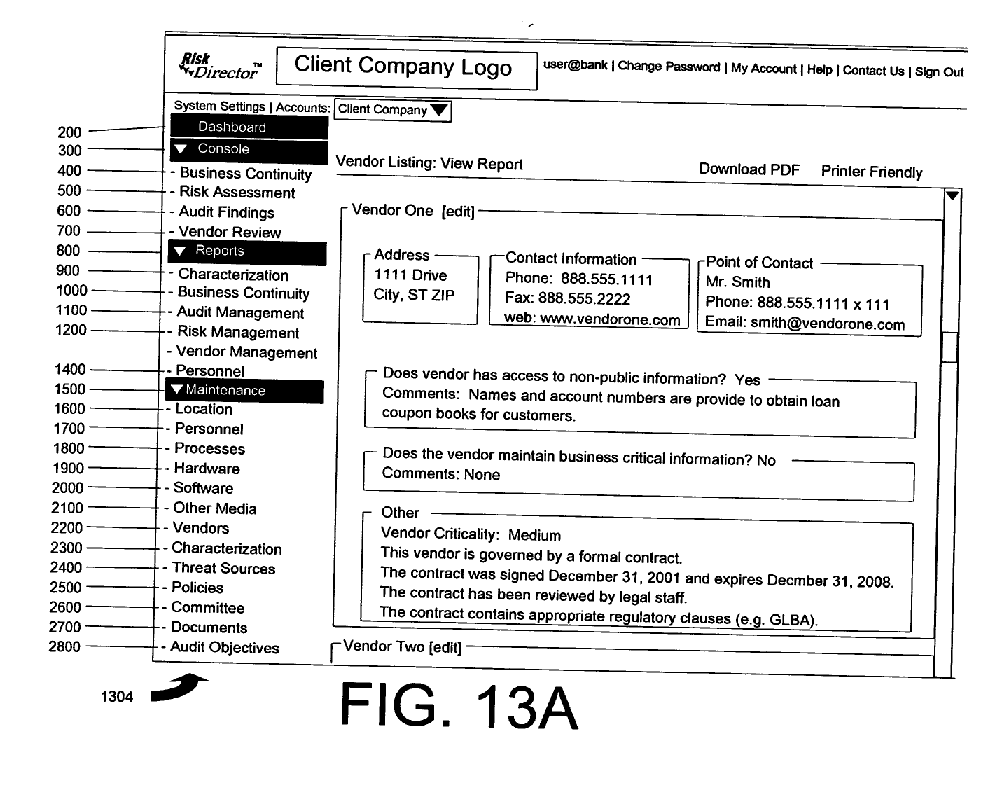

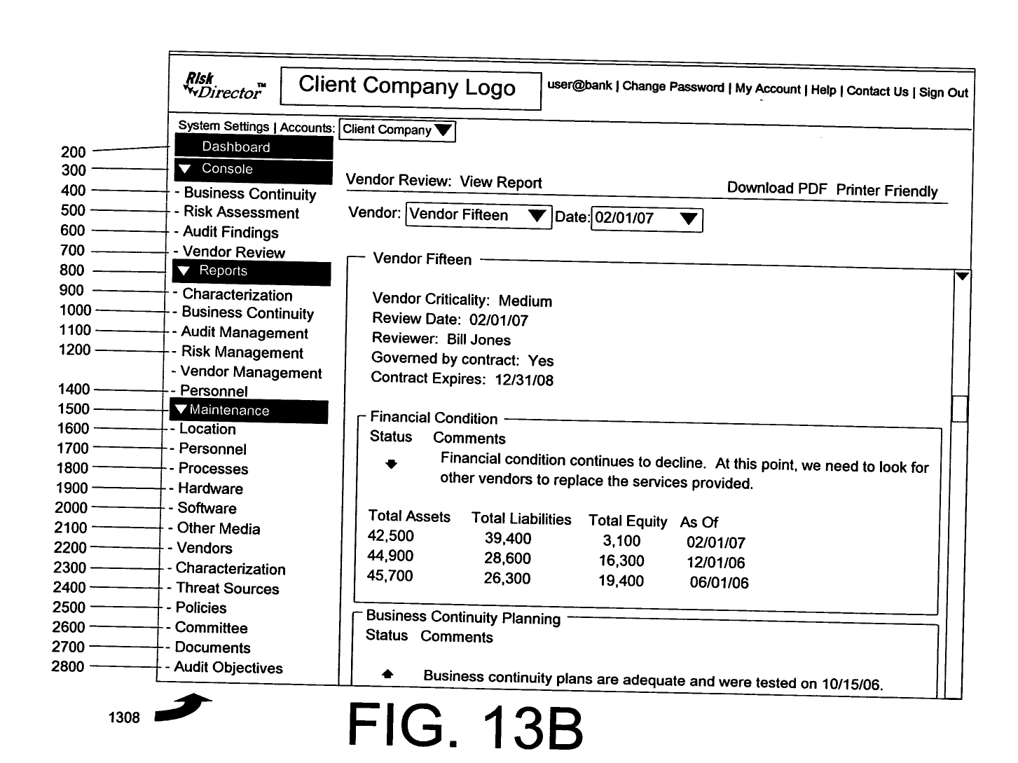

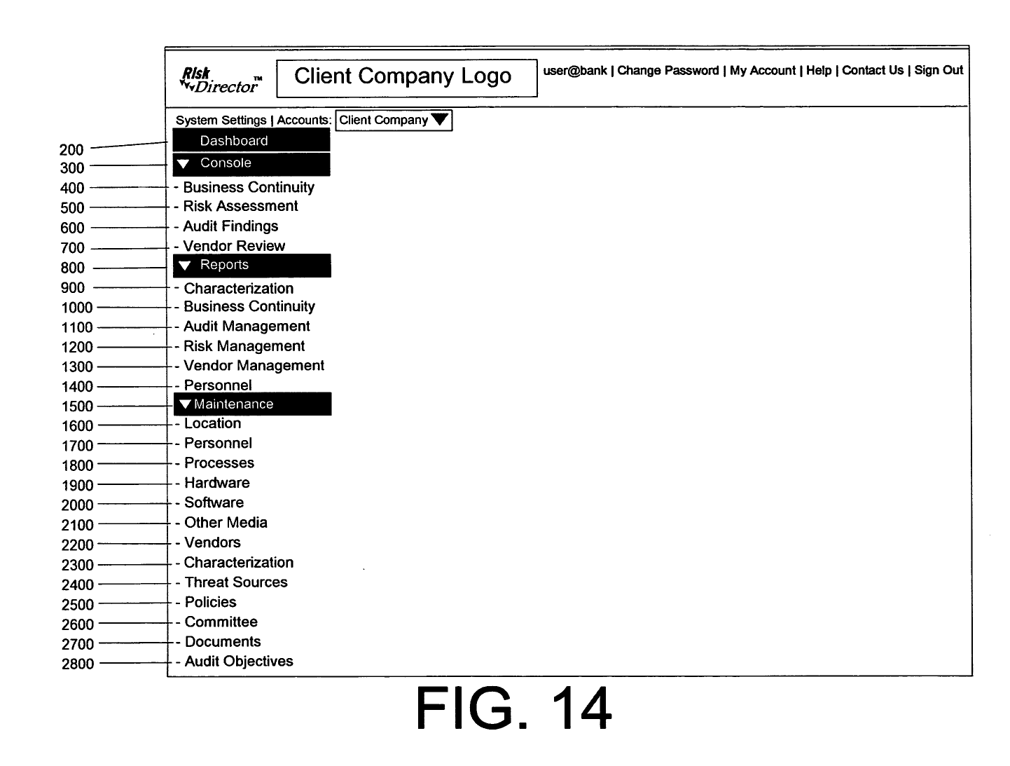

Like the personnel listing report, the vendor listing is accessible from multiple locations within the system 100. The vendor listing report tab 1028, and the vendor listing tab available in the vendor management menu 1300 present the end-user with the same vendor listing report 1304 (FIG. 13). The vendor listing report displays all of a Client's vendors, and includes the vendor's contact information, along with other information indicting if the vendor has remote access to Client data, is governed by a formal contract, and if legal counsel has reviewed the contract, as well as other factors. This report is useful for contacting vendors throughout any business continuity recovery efforts, or for ongoing vendor oversight.

As shown in FIG. 10B, the business continuity test plan report 1036, provides a listing of the test objectives that will be used to evaluate the success or failure of a business continuity test. This report arranges the test plan by business process. As a result, the Client may view the plan in its entirety, or, the report may be limited to one business process. The report allows the Client to view, and approve, the test criteria that will be used to evaluate the business continuity plan, prior to conducting the test. Establishing the criteria beforehand allows for a more objective analysis of the results.

Once a business continuity test has been completed, and the Client has entered the outcome in the business continuity tab 416 (FIG. 4E), the results for each objective will be provided in the test report 1036 (FIG. 10C). The report is organized by business process and includes a summary comment, along with the detailed results of each test objective. The report can be generated by the last test date all business processes or by a specific date for a particular business process. This report provides documentation of the adequacy of the Client's business continuity plan. This information may be important to key stakeholders, such as management, customers, shareholders, partners, and regulators.

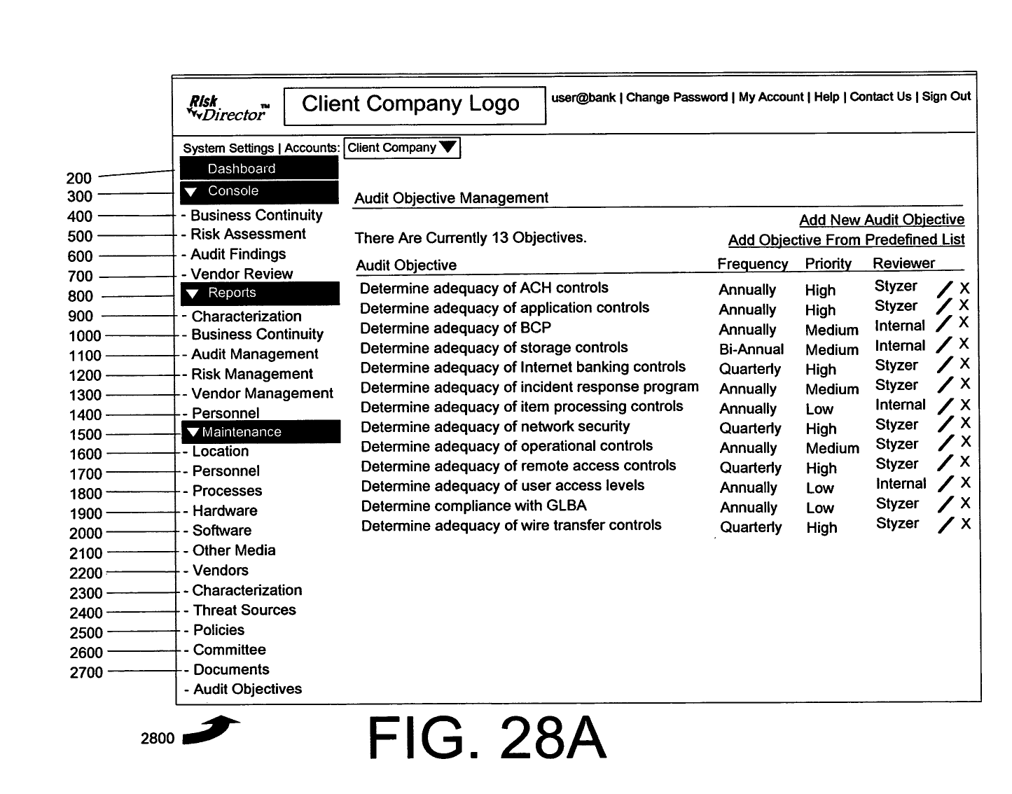

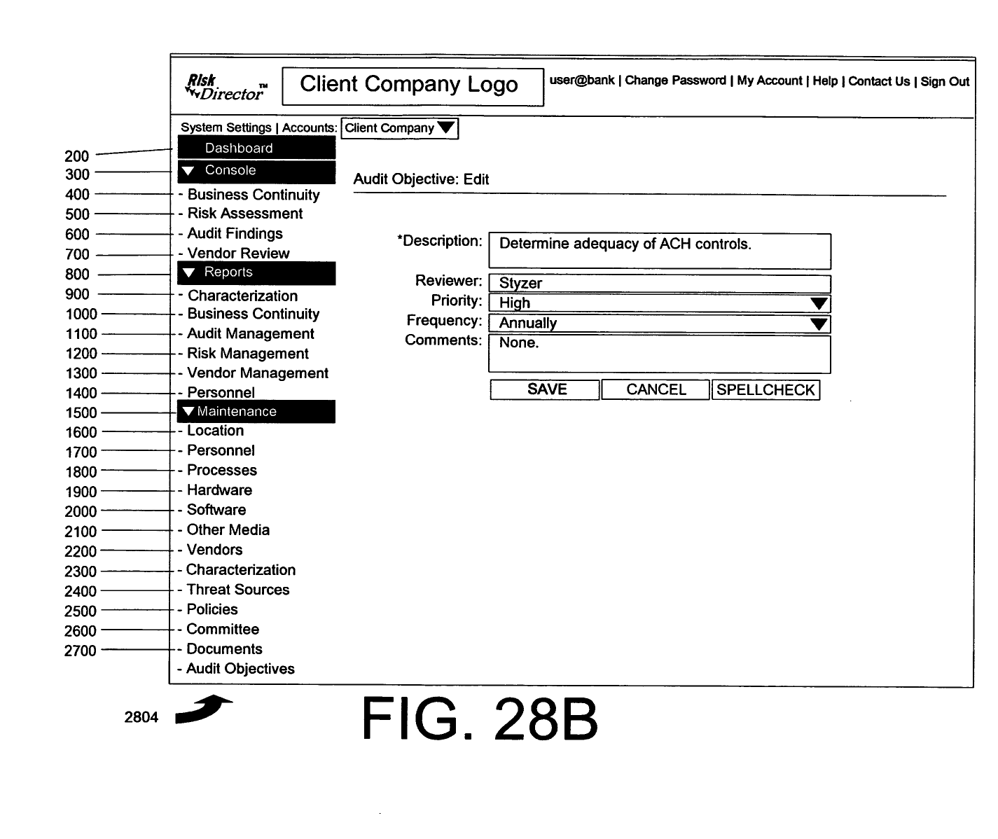

The audit management reports tab 1100 is shown in FIGS. 11A 11B, and 11C. As shown in FIG. 11A, an audit/test plan (summary) tab 1104 provides a listing of the audit objectives and identifies the responsible party for performing the review, along with the frequency of the review. The audit objectives are edited in the audit objectives tab 2804 (FIG. 28B). This report provides the Client with an overview of their audit plan.

The audit/test objectives (details) report 1108 (FIG. 11B) details the mitigation strategies (e.g. controls) that should be considered during the audit. These mitigation strategies were assigned to a specific audit objective during the risk assessment process. This report allows an auditor to map their audit work program (i.e. detailed review procedures) to Client's audit objectives, which ensures that the audit procedures performed validate that mitigation strategies identified during the risk assessment are in place and working as intended. Without such a mapping, the auditor's scope of activities may, or may not, include a review of all pertinent controls.

The audit findings report 1112 (FIG. 11C) details the findings from various reviews that were entered through the audit findings tab 600. This report documents the priority level of the finding, the responsible party for implementing corrective action, the due date for corrective action to be completed, and the percent of corrective action completed. The report contents may be ordered by any of the report headings, such priority, due date, or percent complete. This report helps the Client ensure that identified control deficiencies are corrected in a timely manner.

The risk management report tab 1200 is shown in more detail in FIGS. 12A-C. As shown in FIG. 12A, an unmitigated risk report 1204 documents the risks that exceed the approved risk tolerance level. The report includes all the information relating to a specific risk that was added during the risk assessment. This information includes items such as the risk level, residual risk level, probability level, impact severity, and the associated mitigation strategies and its status (e.g. “in place” or “planned”). Because this report documents risks in excess of the approved risk tolerance, the report includes an impact statement to assist the approving party in making a risk management decision, such as accepting the risk as presented or requiring further mitigation. The report is organized by business process and the end-user can select to view all business processes or limit the report to a specific business process. This report ensures that appropriate personnel within the Client organization are apprised of any unmitigated risks within the Client's business processes.

The risk mitigation report (not shown) contains the same information as the unmitigated risk report, but is not limited to displaying only the risks exceeding the approved risk tolerance level. This report includes all risks and related mitigation strategies, even those risks that are below the approved risk tolerance level. This report allows Client management to view the documented control environment for the organization by listing all business processes, or the end-user can limit the report to a specific business process. This report provides Client operating management with detailed representation of the risks and associated controls within their business unit.

As shown in FIG. 12A, a particular risk is numbered. The identification number (ID) is unique and would not be used again. When any risk is added, the software 100 increments the risk identification number. If the risk is referenced anywhere else in the system 100, such as the reports, the risk will be identified by that number. This feature is useful when discussing risks with numerous people, by ensuring that there is no confusion relating to the item in question. The reports allow the end-user to prevent the identification number from being displayed. This feature is useful to print a report that is not cluttered with informational data.

A security requirements checklist report 1208 (FIG. 12B) displays all of the mitigation strategies by the governing document (e.g. policy or charter) that will formally implement the specific mitigation strategy. The association of mitigation strategy to policy was assigned by the end-user during the risk assessment process (FIG. 5D). This report helps the end-user maintain adequate policies, by detailing the mitigation strategies that a particular policy should address. Otherwise, the Client's formal policies may not reflect the desired, or needed, control environment. From the security requirements checklist, and other risk management reports, the end-user can select an icon that will return the end-user to the risk assessment edit page 512 (FIG. 5D), to modify the contents of the selected item. This feature is available in all reports that are tied to a specific edit menu, such as with audit findings and risk reports.

A key controls report (not shown) details a subset of mitigation strategies that the end-user designated as “key” during the risk assessment. This report could be used for regulatory compliance purposes by providing a report on a subset of controls, such as the financial industry's requirement to identify key controls relating to the safeguarding of non-public customer information.

A control gap report 1212 (FIG. 12C.) details mitigation strategies that are not currently implemented. This report helps the Client monitor the status of the mitigation strategy implementation. Without such a report, the implementation of specific mitigation strategies could easily be overlooked by a Client, resulting in an insecure operating environment. The unimplemented mitigation strategies are organized by business process, and the end-user may view all unimplemented controls or limit the report to a specific business process. Like other reports, the end-user can select the edit icon to return to the appropriate risk management edit menu in order to modify the mitigation strategy status.

The present invention provides two reports in the vendor management report tab 1300. The vendor listing report 1304, discusses earlier, is a depicted on FIG. 13A. The other report relates to vendor reviews. The vendor review reports (FIG. 13B) provide the detail of the Client's vendor oversight that was entered through the vendor review tab 700. The report contains a “satisfactory” or “unsatisfactory” arrow indicator, along with any comments the end-user may have added for the review components. The report may be viewed by the last review for all vendors or by any historical review date for a specific vendor.

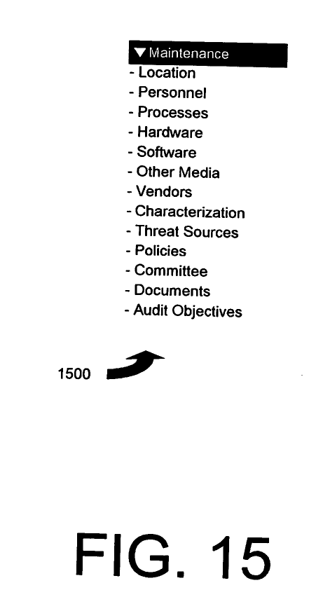

The maintenance menu 1500 contains all the items that do not change frequently. However, the majority of the maintenance information must be populated before some of the risk management tasks from the console menu 300 are attempted, such as business continuity. The maintenance menu 1500 (FIG. 15) is where Client operating locations (physical addresses) are identified, and also where information assets (hardware, software, other media, and vendors) are identified and associated with a business process. Although this information does not necessarily change frequently, it is referenced by many functions within the system 100.

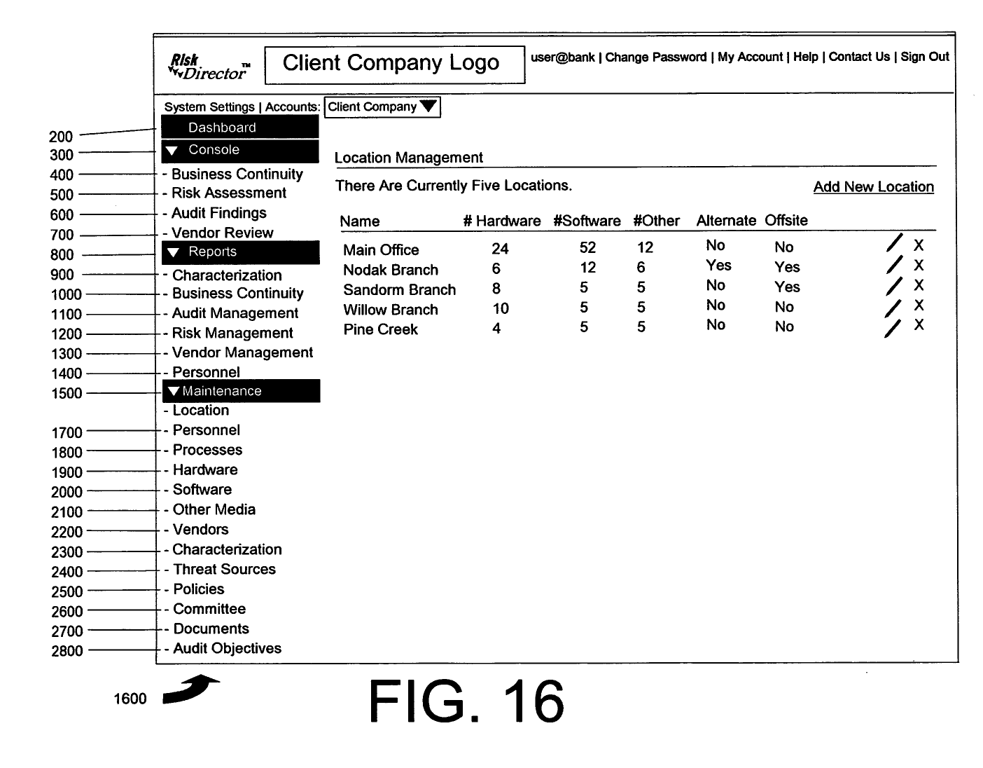

The location tab 1600 (FIG. 16) provides an interface to add, delete, or modify physical locations (i.e. street address). The defined locations are used to identify the locality of hardware, software, other media, alternate processing facilities, and offsite storage locations, among other things. The main menu displays the number of hardware and software items assigned to each location, along with identifying if the location is used for offsite storage or is an alternate processing facility.

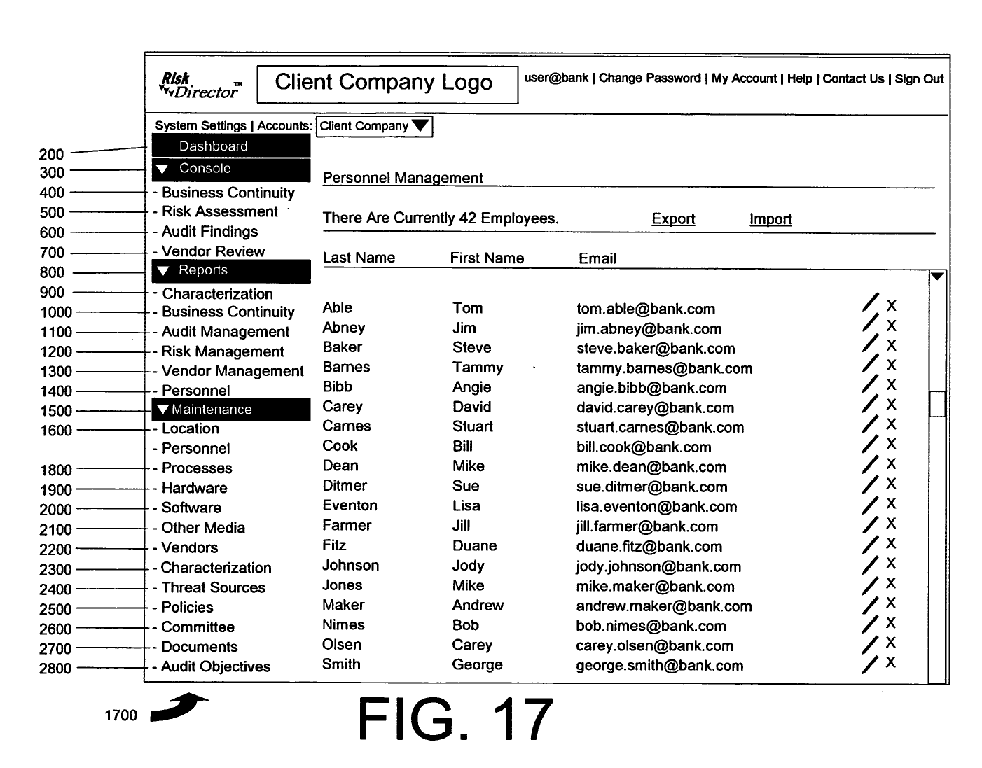

The personnel tab 1700 (FIG. 17) provides an interface to add, delete, or modify personnel information. Selecting the edit icon would allow the end-user to modify various attributes, such as contact information, hiring date, and whether the person has been authorized remote access to Client data. An accurate listing of personnel is needed for the risk management process, such as business continuity planning. The system 100 allows the end-user to import and/or export this information in a comma separated values file (.CSV). The export feature allows the Client to use this information for other purposes, while the import feature minimizes the end-user's effort to populate the system 100, if the information is available from an outside source. This ability is provided in several aspects of the present invention.

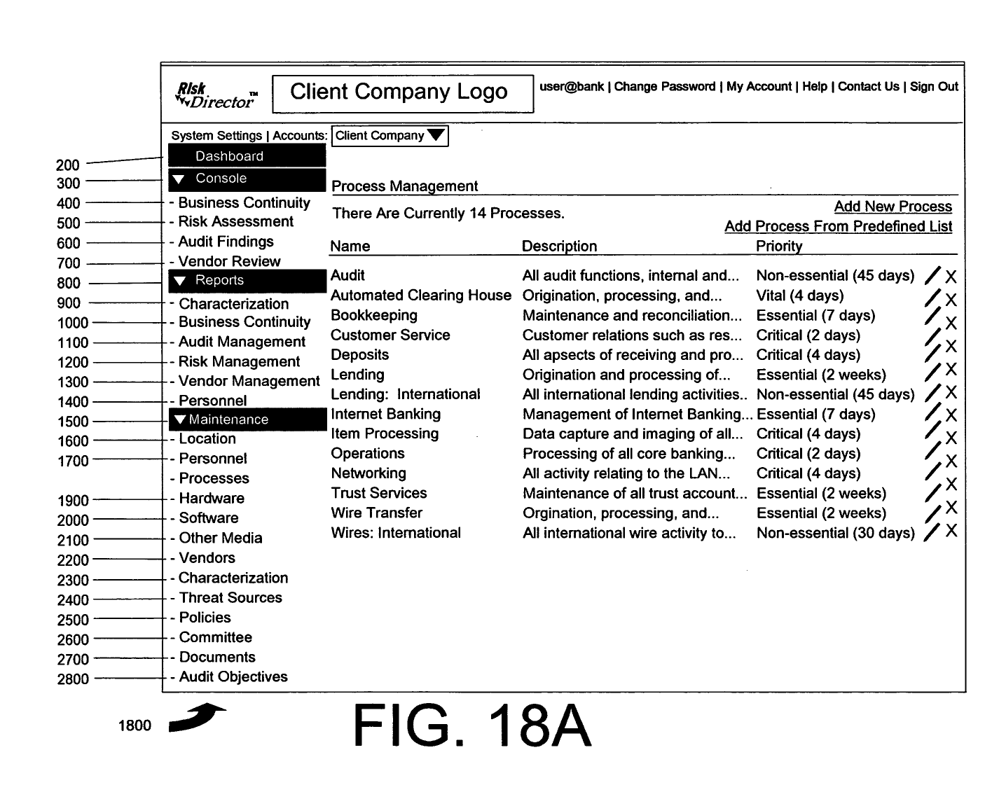

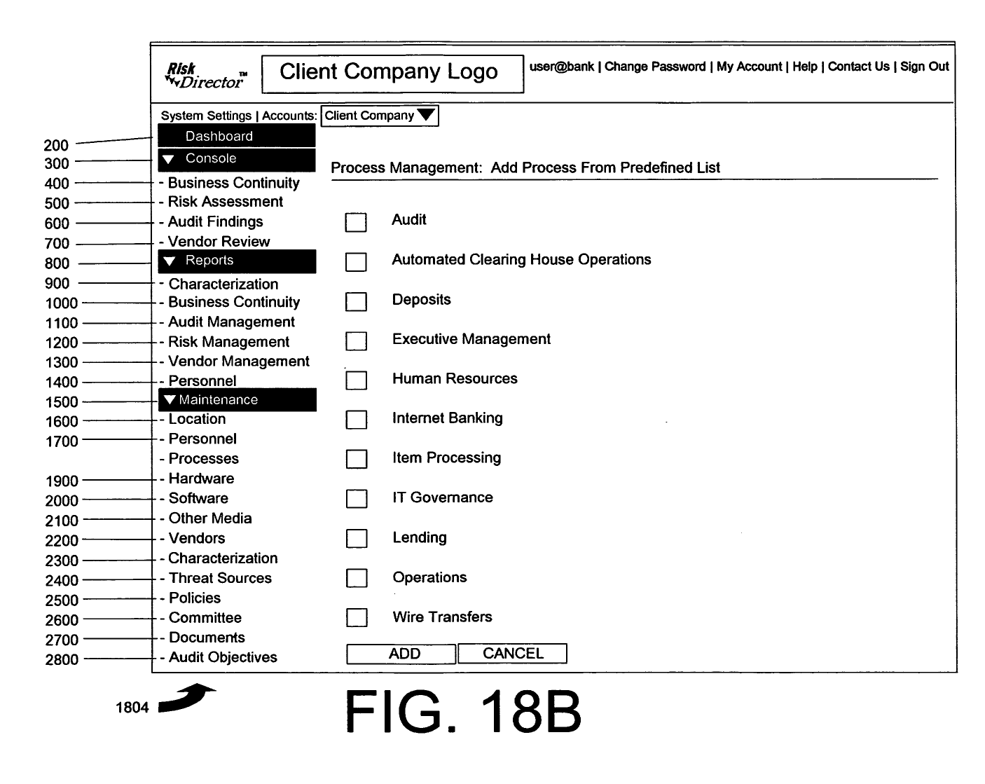

The processes tab 1800 (FIG. 18A) provides an interface to add, delete, or modify business processes. Selecting a specified business process would allow the end-user to edit the process name or description. With the proper authority granted, the end-user may select from a list of processes from the predefined list screen 1804 (FIG. 18B). Once selected, the process may be modified as necessary. This feature allows the end-user to populate the system 100 easily. Defining the business process is necessary in system 100 to organize risk management tasks, such as the assessing risk and business continuity planning.

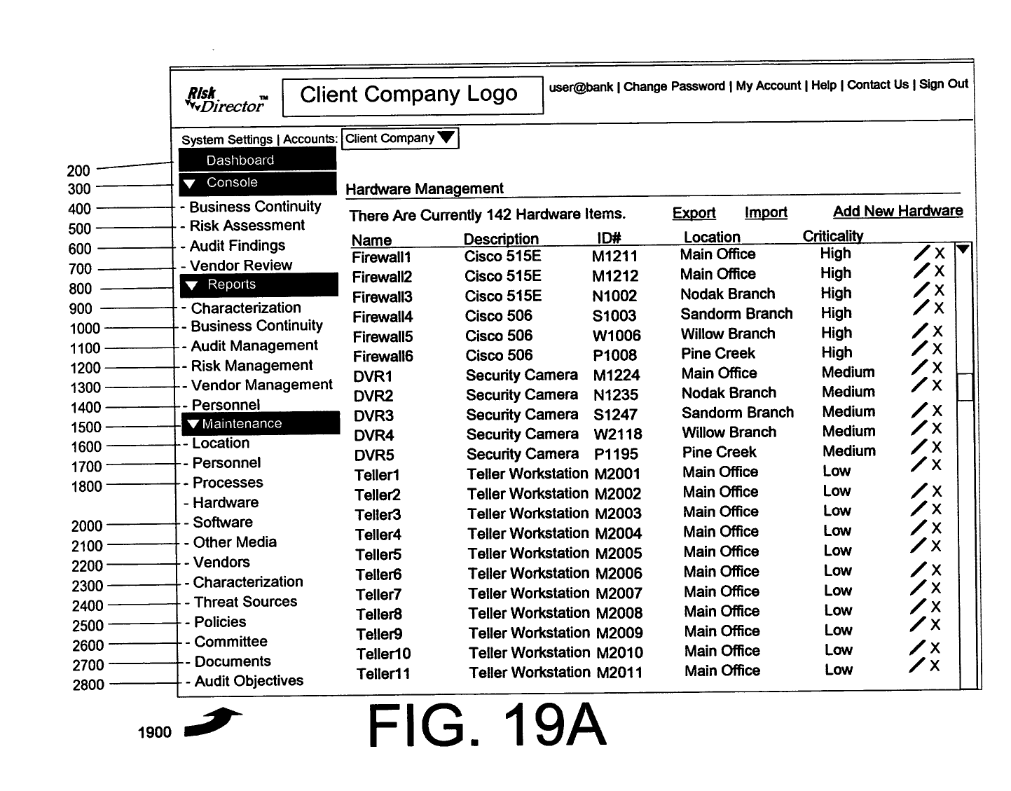

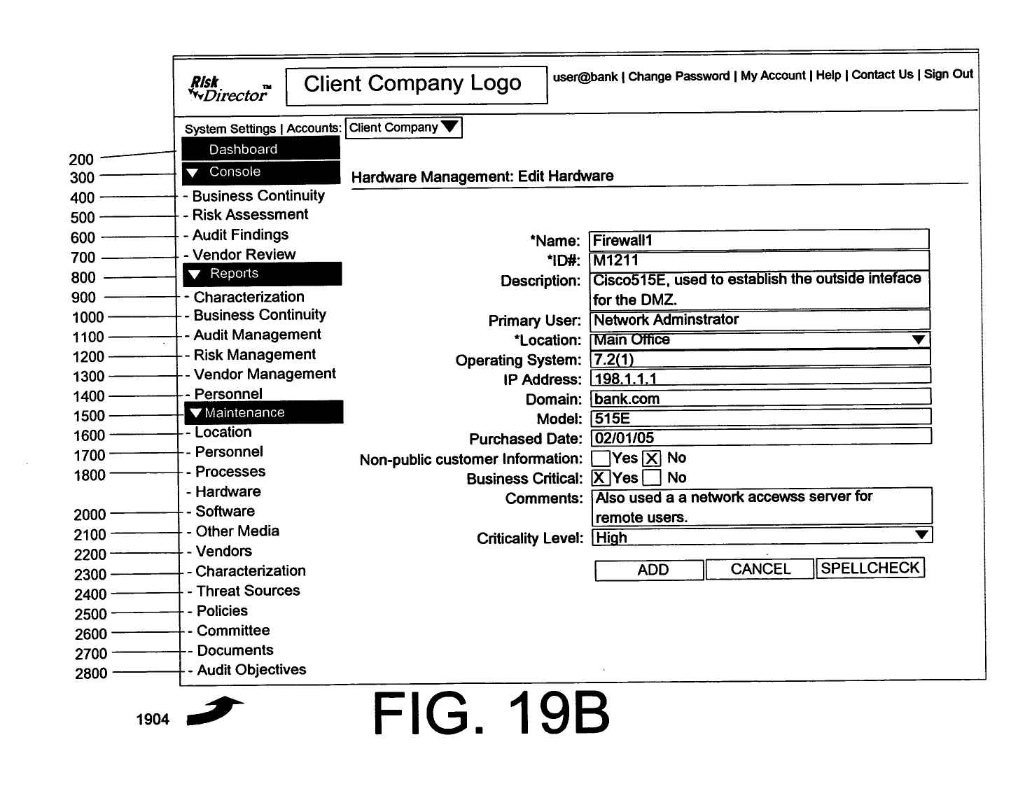

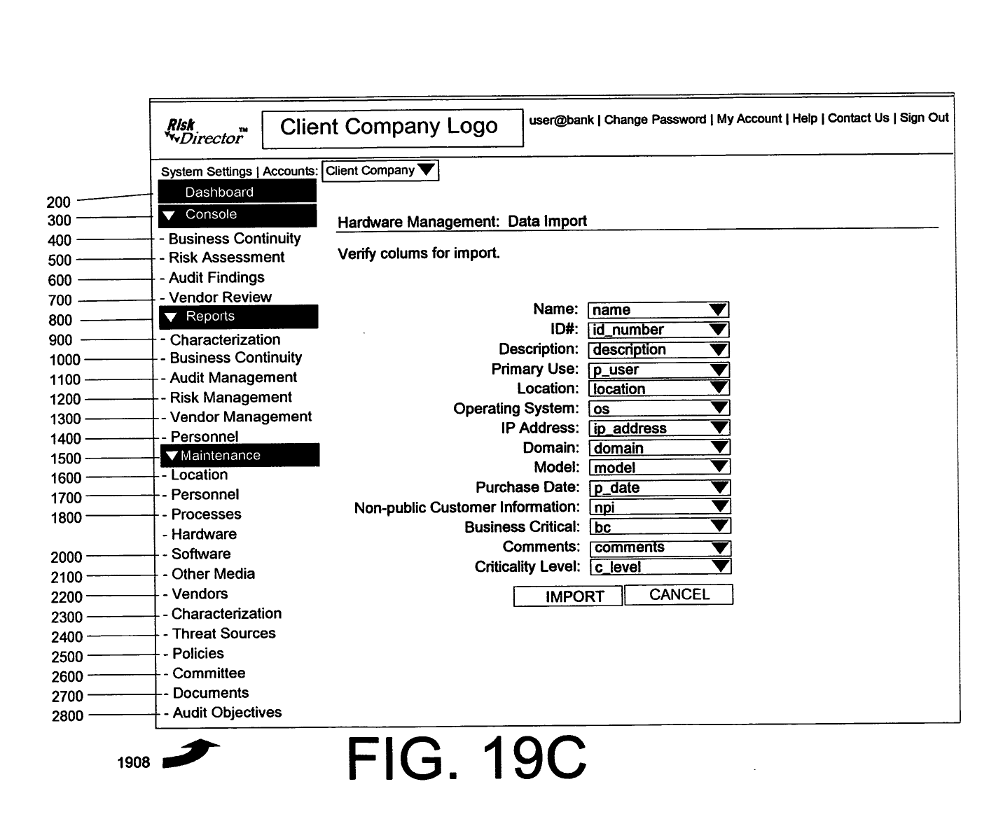

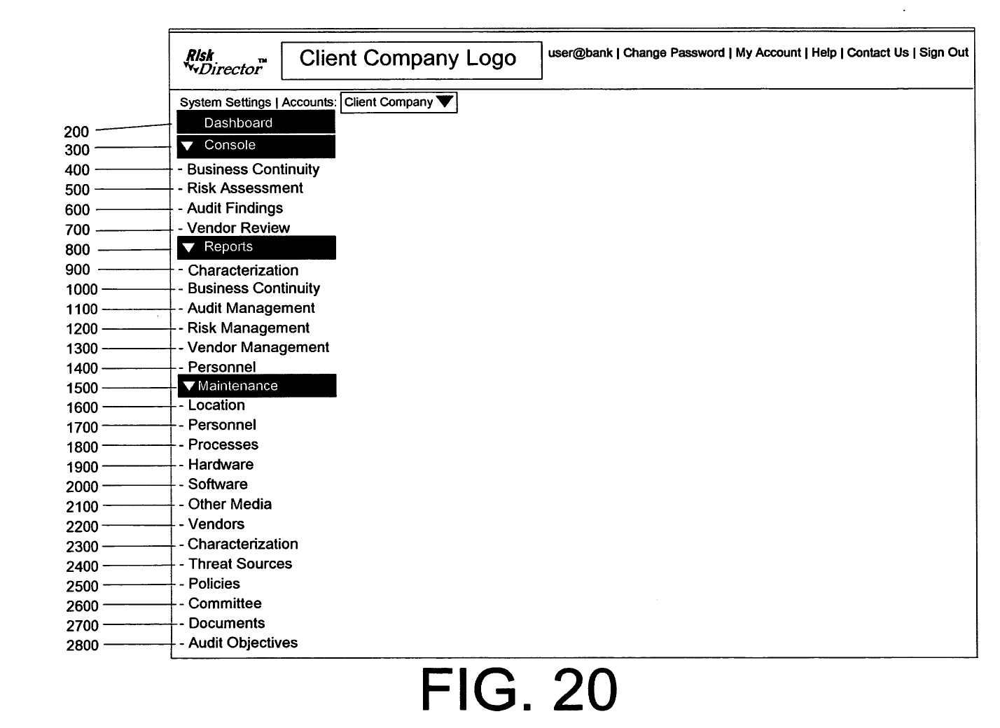

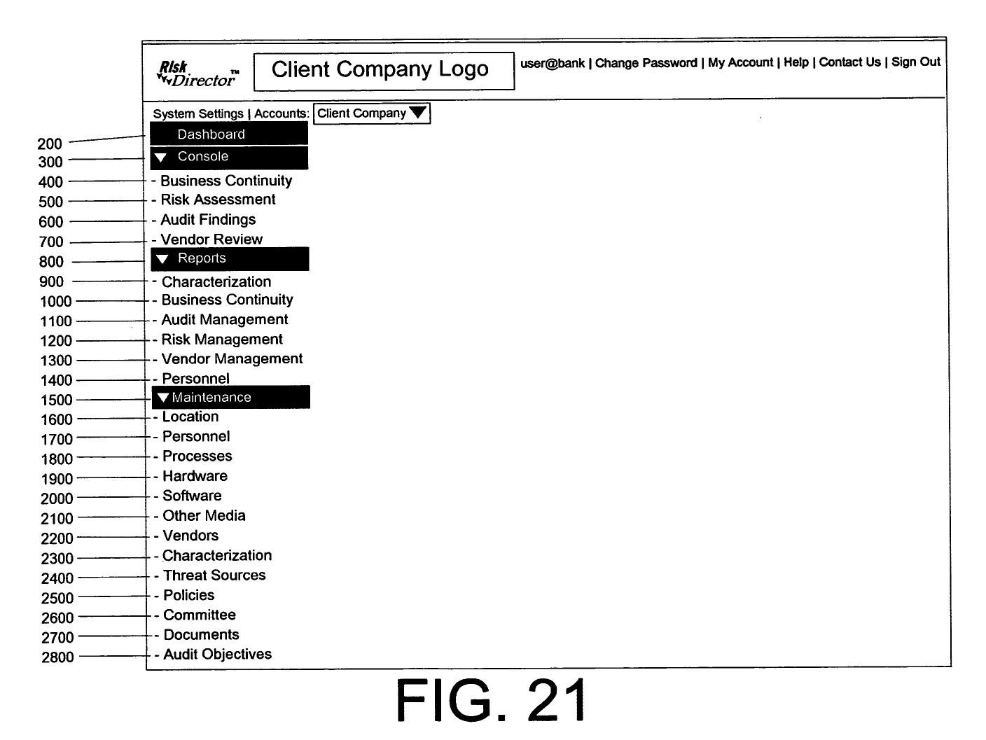

The hardware tab 1900 (FIGS. 19A-C) provides an interface to add, delete, or modify hardware inventory. As shown in FIG. 19B, the end-user may document many attributes of the hardware, to include identifying if non-public customer information or business critical data is maintained on the system. Documenting hardware is essential to identify critical information assets for the risk management process, such as business continuity planning. The system 100 allows the end-user to import and/or export this information in a comma separated values file (.CSV). The import interface 1908 is displayed on FIG. 19C. This interface is the same for all functions within system 100 that allow importing of data from external sources, with the exception that the field mapping would be applicable to the component of system 100 (e.g. personnel, hardware, software, vendors) being imported.

The software tab 2000 provides an interface to add, delete, or modify software inventory. The end-user may document many attributes of the software, such as version, number of licensees, license key, along with identifying if non-public customer information or business critical information is processed or accessed by the software application. Documenting software is essential to identify critical information assets for the risk management process, such as business continuity planning. The system 100 allows the end-user to import and/or export this information in a comma separated values (.CSV) file.

The other media tab 2100 provides an interface to add, delete, or modify other media, which includes information assets other than hardware or software, such as paper documents. Documenting other media is essential to identify critical information assets for the risk management process, including business continuity planning. The system 100 allows the end-user to import and/or export this information in a comma separated values file (.CSV).

The vendors tab 2200 (FIG. 22A) provides an interface to add, delete, or modify vendor information. Documenting all vendors is needed for the risk management process, such as business continuity planning and vendor oversight. As shown in FIG. 22B, the end-user may document a variety of information relating to each vendor. This information includes, but is not limited to, the vendor's contact information, and indicating if the vendor has remote access to Client data or handles any non-public customer data of the Client. The timeframe between vendor reviews is changed here as well. The system 100 allows the end-user to import and/or export this information in a comma separated values file (.CSV). As described earlier, the end-user has the option to upload supporting documents, such as the vendor's financial statements through the vendor document upload interface 2208 (FIG. 22C).

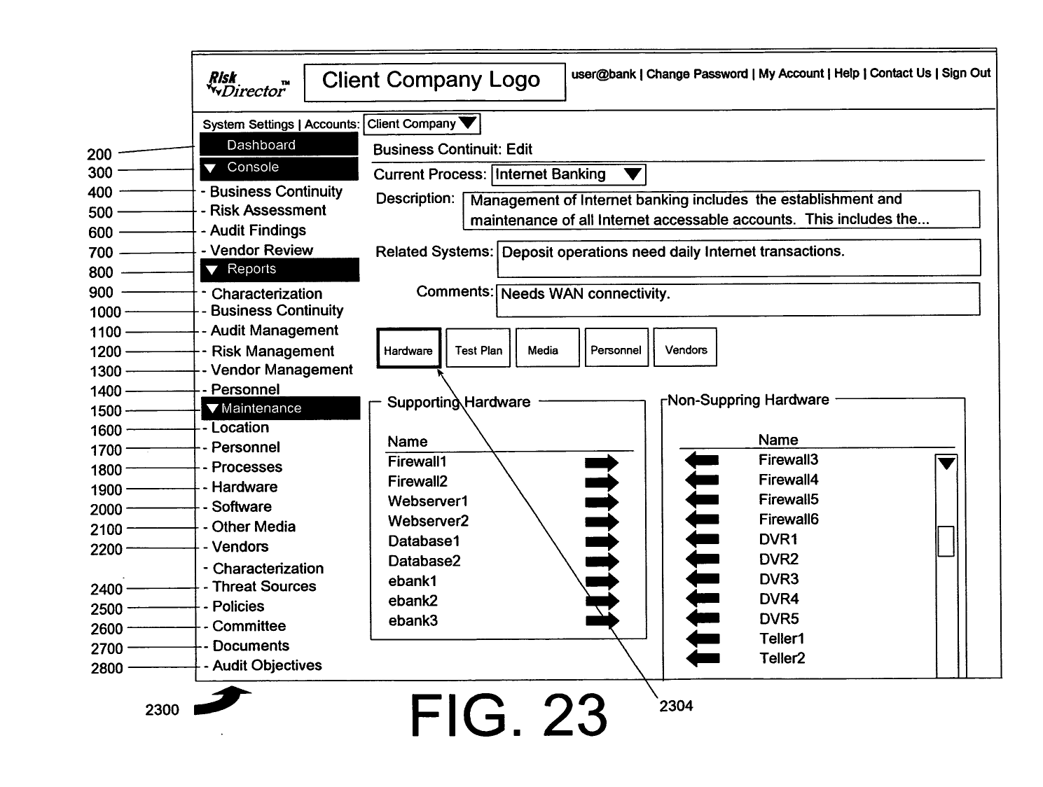

The characterization tab 2300 (FIG. 23) provides an interface to associate the information assets to a specific business process (e.g. business unit). For example, a financial institution's Internet banking unit may have an institution controlled database server containing customer balances, institution controlled software to manage the database, and an outsourced front-end web server that customers use to interface with the institution's database. The characterization tab allows the Client to associate all of these items (and any other appropriate hardware, software, vendors, other media, or personnel), to the Internet banking business process. This step is critical for the risk management process as the associations are important to the various functions, such as risk assessment, business continuity planning, vendor oversight, and auditing. This ensures that all relevant information assets of a business process are documented; which, in turn, minimizes the likelihood that the items would be overlooked during risk management tasks. To accomplish the association, the end-user would select the appropriate tab, such as hardware 2304 (FIG. 23). Once selected, the end-user would associate the appropriate items in the non-supporting column into the supporting column by selecting the left facing arrow. Disassociating an item can be accomplished by selecting the icon next the desired item in the supporting column. The process can be completed for hardware, software, other media, personnel, and vendors, all of which were added from the maintenance menu beforehand.

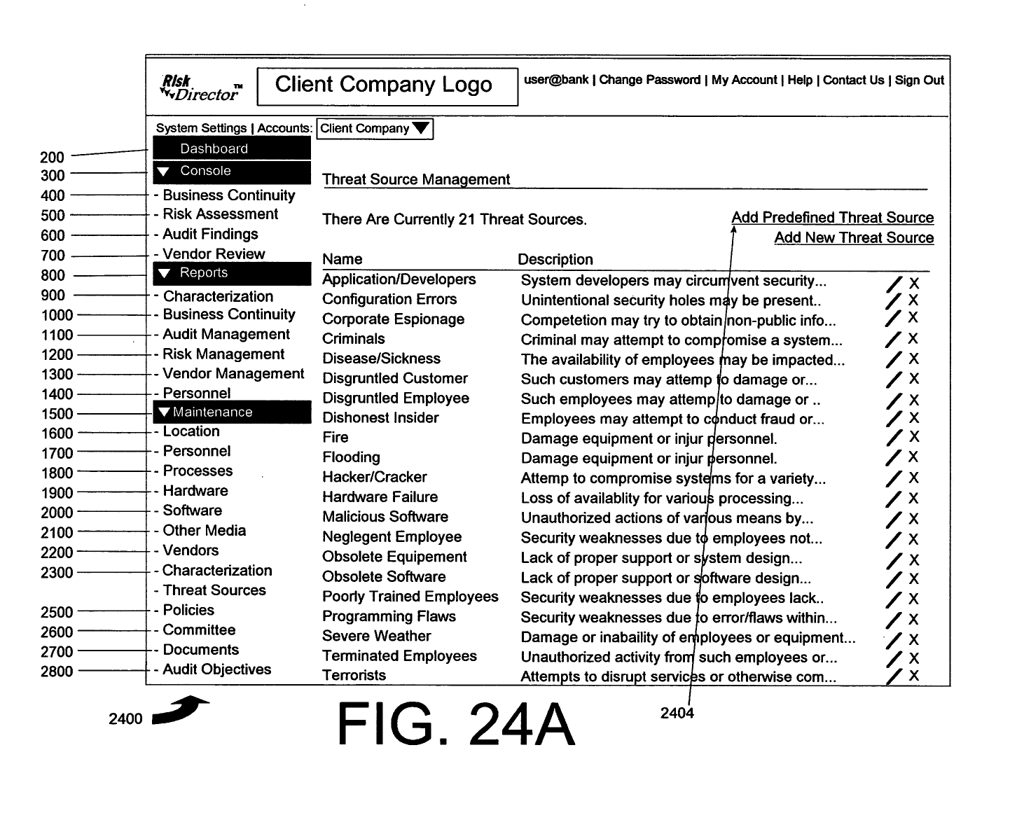

The threat sources tab 2400 (FIG. 24) provides an interface to identify the various threat sources that will be considered during the risk assessment process. As the name implies, threat sources are the sources of the various risks. For instance, if a Client operates near the gulf coast should consider hurricanes as a threat source. The Client should then identify the appropriate risks that may stem from such a threat source, such as flooding in the above example. Whereas, risks stemming from tornados, may be a more appropriate choice for a Client operating in the Midwest. The different threat sources will likely result in a variety of risks and corresponding risk mitigation strategies. With proper authority granted, the end-user may select the add predefined threat source link 2404 (FIG. 24A) to obtain a listing or predefined threat sources 2408 (FIG. 24B). Once chosen, the identified threat sources will be incorporated into the Client's system and may be modified as necessary.

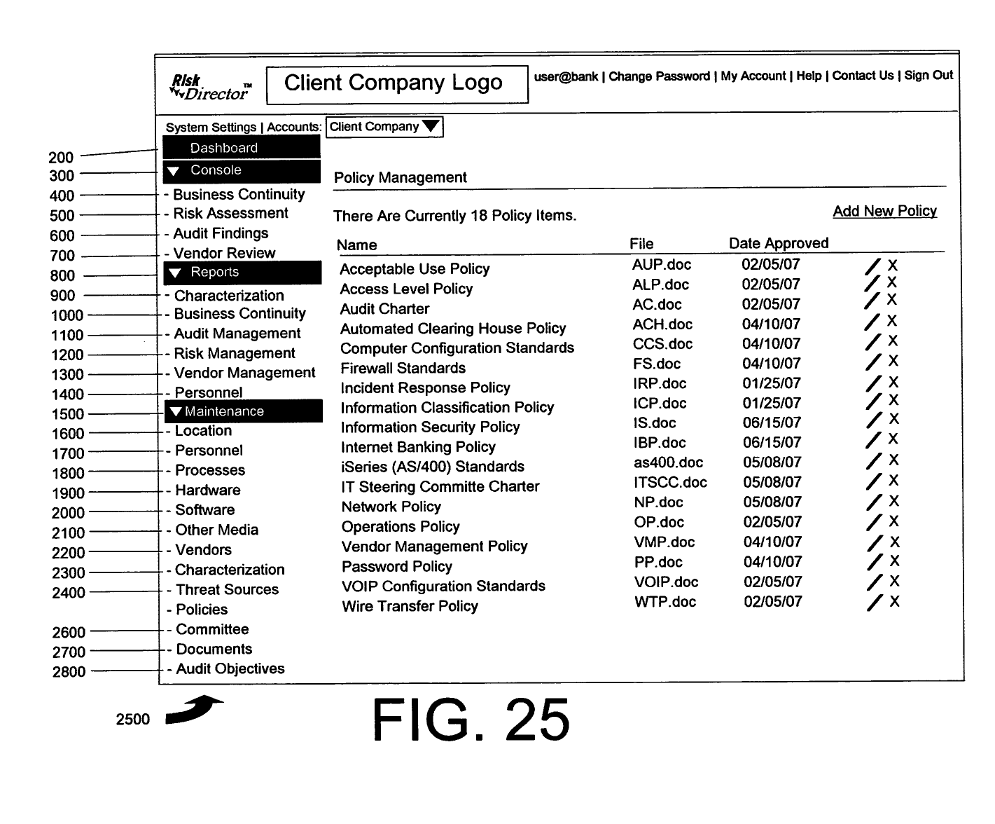

The policies tab 2500 (FIG. 25) provides an interface to add or delete policies and other governing documents. During the risk management process, mitigation strategies should be associated to the policy that will implement the strategy, as indicated in FIG. 5D. The policies available in risk edit menu 51 2 (FIG. 5D) are governed by the list of policies identified in this policy tab 2500 (FIG. 25). The term policy refers to any type of governing document, such as an audit charter or an Internet banking policy. The actual policy document can be uploaded to the system 100 of the present invention.

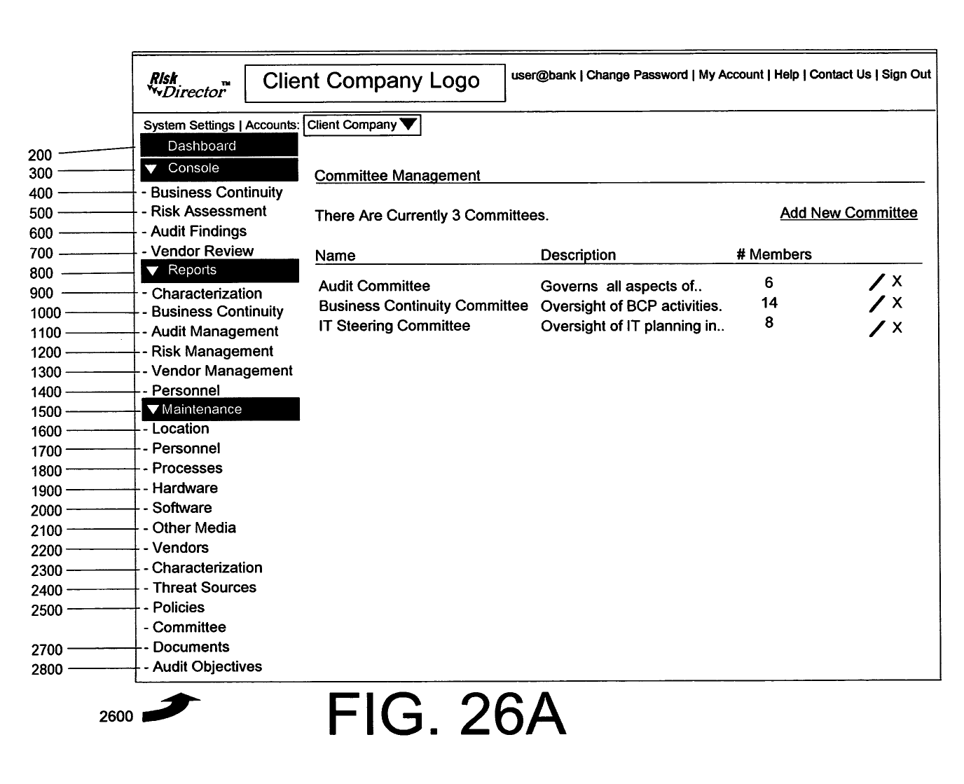

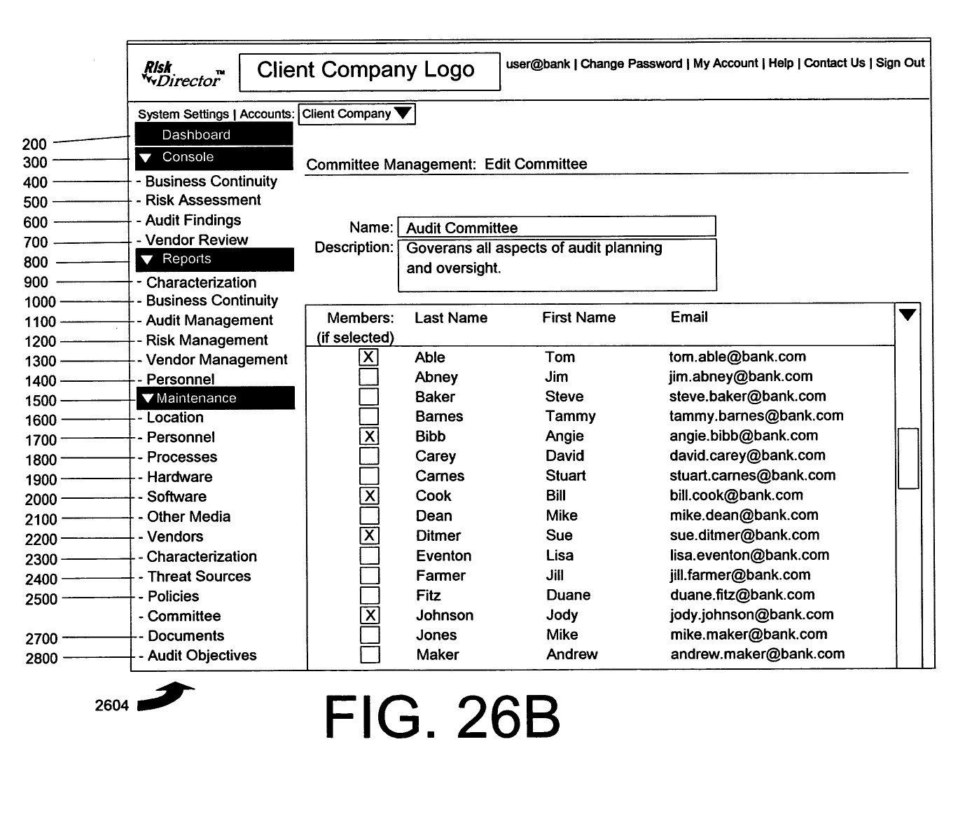

The committee tab 2600 (FIG. 26A) provides an interface to add, delete, or modify Client committees. Selecting the edit menu allows the end-user to assign membership in various committees (FIG. 26B). Future plans include having the system 100 provide oversight of committee meetings by documenting attendance and allowing the end-user to input comments and upload supporting documents.

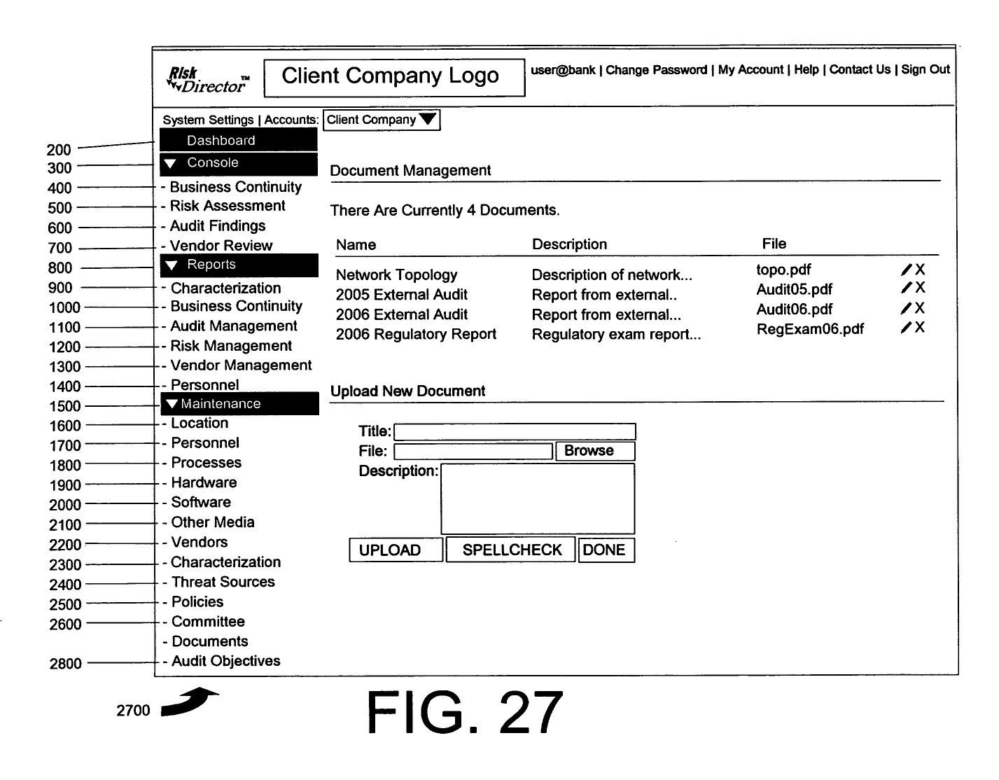

The documents tab 2700 (FIG. 27) allows the end-user the ability to upload various Client documents that relate to the risk management process. For instance, the institution may chose to upload their network topology or their last audit report. This feature is similar to the capability provided by the upload vendor documents function, with the exception that these documents related to the Client, not a specific vendor. The ability to have supporting documents readily available allows the Client to justify particular risk management decisions made within system 100 of the present invention.

The audit objectives tab 2800 (FIG. 28A) provides the interface to add, modify, or delete audit objectives used during the risk management process. One aspect of the invention is to detail the mitigation strategies derived from the risk assessment into an audit/test plan. To populate the audit plan, the end-user assigned the mitigation strategies to an audit objective in the risk assessment tab 300 (FIG. 5D). These objectives, including the mitigation strategies assigned to them, then become the audit/test plan. If a risk was selected from a predefined list, as indicated in FIG. 5E, the audit objective associated with the recommended mitigation strategies would have been populated into this menu as well as the risk assessment. Once developed, the Client then uses the audit/test plan to ensure that each objective is assigned to an independent and qualified reviewer. The assignment is conducted through the audit objectives tab 2804 (FIG. 28B). The review may be conducted by internal staff, an external firm, or a combination of both. Having the ability to assign audit reviews to different entities allows the Client to allocate audit resources efficiently. As indicated earlier, when an auditor reviews their assigned audit objectives, they should determine if the associated mitigation strategies are actually in place. If they are not in place, the discrepancy should be documented in the audit findings tab 600 and tracked until corrective action is implemented. Like other aspects of the system 100, audit objectives may be selected from a predefined list. The audit objectives entered in this menu (or populated by selecting predefined lists) will be available to the end-user to assign to mitigating strategies during the risk assessment process, such as indicated in FIG. 5E.

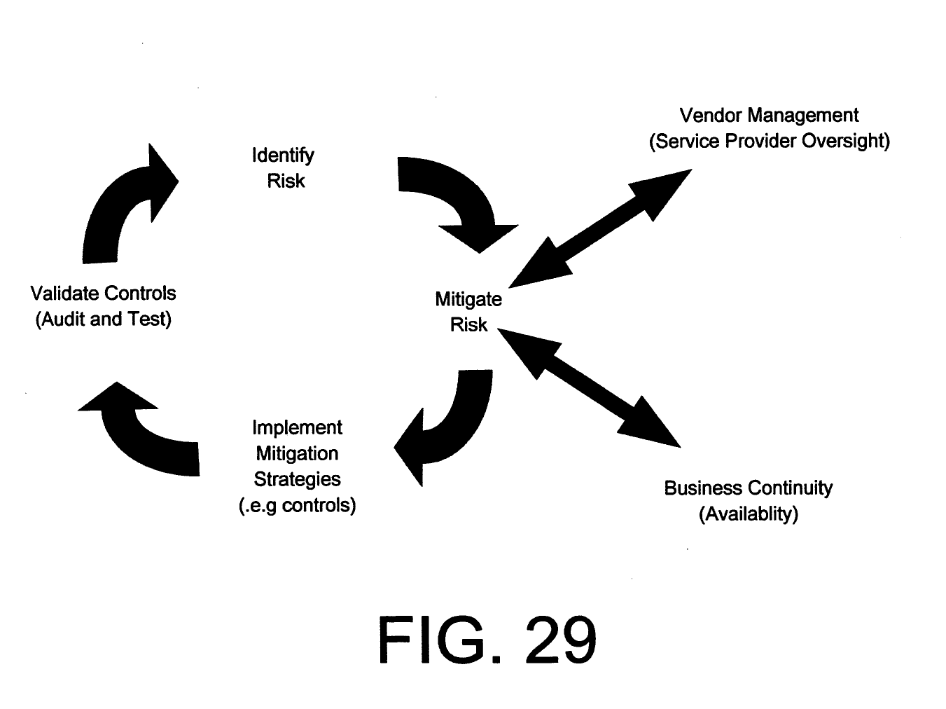

FIG. 29 provides an overview of how the risk management process is a cycle that should be repeated over and over. The present invention facilitates this process by providing a framework that allows the Client to continually update the appropriate items within the framework, such as identifying risk or validating controls.

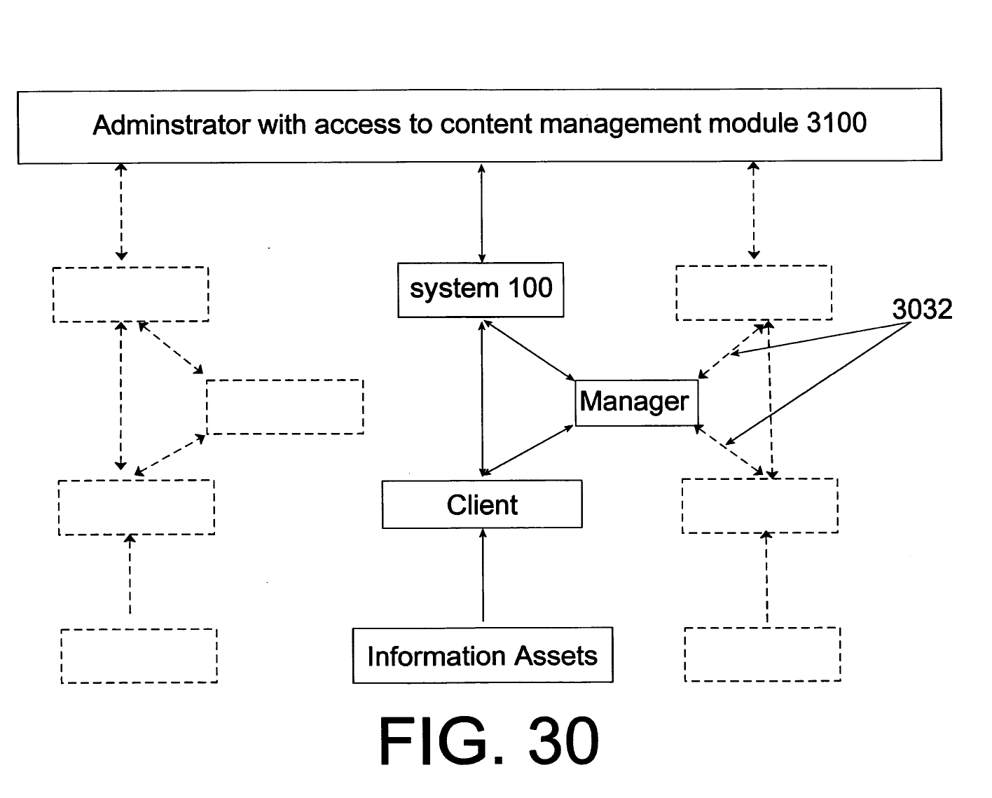

FIG. 30 shows detail about the business method principles of the present invention. FIG. 30 incorporates the initial framework of the invention shown in FIG. 1 into a larger commercial framework, which can include numerous Managers of the system 100 and system Administrators (e.g. super user). The Administrator has access to all aspects of system 100 and the content management module 3100, which is the interface for managing the back-end attributes to system 100. This access includes maintaining the various predefined lists. From FIG. 30 it is apparent that an Administrator or Manager can work with many different instances of the system 100. When a Manager accesses system 100, they can switch between their Clients by selecting the chosen Client from a dropdown menu. Once selected, the system 100 for that specific Client will be displayed.

Managers, such as resellers, security consultants, or holding companies, can establish Client instances of system 100 as shown in dashed line 3032. The Managers can view the pre-defined lists when conducting risk management tasks for their Clients. The default lists (or predefined lists) include: business processes (with associated recommended business continuity test objectives), risks and corresponding mitigation strategies along with the mitigation strategy's associated audit objectives and recommended governing policy.

However, it is important to note that the system 100 of the present invention does not actually implement any mitigation strategies. Instead, it is a managerial tool which is used to organize and report on various risk mitigation strategies, and other risk management tasks. The present invention is controlled, set up, and managed by the Client or the Manager of that Client. In general, the Manager is not involved in the inputting of Client data, such as information assets, unless engaged to do so by the Client. Although the Administrator could input data on behave of a Client, the Administrator is generally reserved for adding and managing the Mangers who, in turn, can access and modify information on behalf of their Client.

Thus, being an organizational tool, the present invention does not by itself find items that would be of concern to Client in reducing their risk exposure. However, the predefined lists available to the Managers greatly assist in populating the system 100 with appropriate information that can be further refined by the Client or Manager. An end-user still must enter additional information and/or modify the information supplied by from the predefined list, which is then coordinated through the functions within the system 100 to provide and overall risk management framework as depicted in FIG. 29. The present invention does not verify whether an actual event occurred, and relies on the end-user to input accurate information.

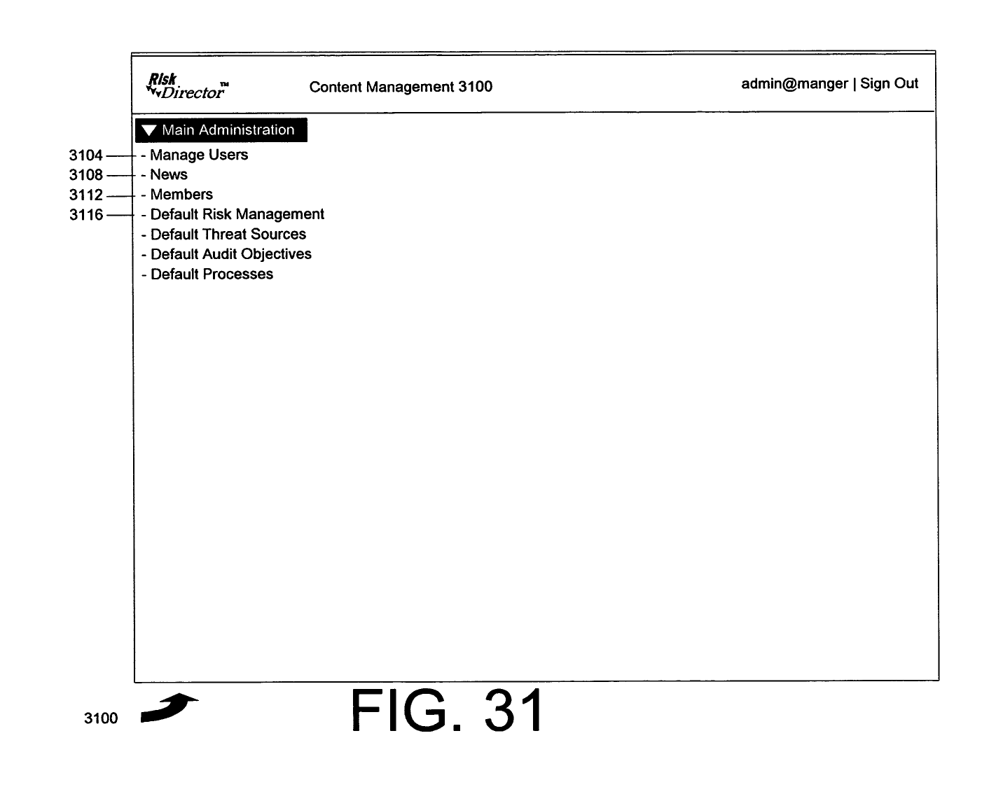

FIG. 31 shows more detail of the content management module 3100 used to access back-end function, such as maintaining the predefined lists used in the system 100. As stated earlier, the content management module 3100 is available only to Administrators. Like the system 100, the various functions are accessed through a menu provided on the left side of the user interface. The manage users tab 3104 allows an Administrator to add/edit/delete personnel that can access the content management module (i.e. other Administrators).

The news tab 3108 allows an Administrator to send messages to one, or all Clients and/or Managers. If the Administrator sends a message, the message will be displayed above the dashboard 200 until the end-user dismisses the message.

The members tab 3112 allows an Administrator to oversee end-users designated as Managers (can access their Client's data), or Clients (access only their own Client data). Similar functionality is provided to each Manager through a “system settings” screen in system 100 that allows Managers oversee their Clients, such as resetting end-user passwords, or adding a new end-user.

The default risk management tab 3116 allows the Administrator to establish predefined risks and mitigation strategies. These risks are organized by category to assist end-users in locating appropriate items when they are conducting a risk assessment. This tab also allows an Administrator to assign a default audit objective and governing policy to a mitigation strategy. When Managers, or an authorized Client, access the system 100 they can select from these predefined lists when performing some risk management tasks.

The default threat tab 3120 allows the Administrator to add, modify, or delete the threat sources that are displayed on the predefined list for Managers, or authorized Clients, when they access threat sources tab 2408 (FIG. 24B). The default audit objectives tab 3124 allows the Administrator to add, modify, or delete the predefined audit objectives, while the default processes tab similarly allows the Administrator to add, modify, or delete the predefined business processes list.

As depicted in FIG. 30, the present invention allows a Manager to give a Client access to the system 100 so that the Client can conduct the risk management tasks. Without the invention, many companies (e.g. consulting firms) that provide risk management services, such as conducting risk assessments, would only be able to provide a Client with a mere paper report. Such companies attempt to conduct these risk management tasks through spreadsheets, and word processing documents. Meanwhile, the system 100 of the present invention gives the Client access to a tool to generate and maintain such a report. A Client can maintain the system 100 themselves, or there may be a collaborative effort with a Manager. In addition to providing a framework for risk management, the predefined lists within the present invention provide the end-user valuable information that may take an end-user a significant effort to amass, if possible.

There are other advantages of using the system 100 of the present invention. For instance, once a Client establishes their risk assessment profile, that risk profile is not likely to change significantly over time. Generally, a Client will have the similar risks from year to year. For example, if a financial institution has offered Internet banking to their customers for several years, the risks involved do not generally change from one year to the next.

However, if the same institution adds the ability to transfer funds electronically to other entities via their Internet banking platform, the institution's risk assessment should be adjusted to reflect the additional risks associated with the new transfer capability. The present invention provides the Client the means and resources to update their risk assessment and corresponding items that rely on the risk assessment, such as the audit plan.

Several aspects of system 100 may be customized for a specific Client. For instance, a Client may be granted access to the predefined lists, which are generally reserved for Managers.

At least portions of the present invention are intended to be implemented on one or more computer systems (such as, for example, see FIG. 1, system 100). As known to one of ordinary skill in the art, such a computer system typically includes a bus or other communication mechanism for communicating information, and one or more processors coupled with the bus for processing information. The computer system also includes a main memory, such as a random access memory (RAM) or other dynamic storage device, coupled to the bus for storing information and instructions to be executed by the processor. The main memory also may be used for storing temporary variables or other intermediate information during execution of instructions to be executed by the processor. The exemplary computer system may further include a read only memory (ROM) or other static storage device coupled to the bus for storing static information and instructions for the processor. A storage device, such as a magnetic disk or optical disk, is provided and coupled to the bus for storing information and instructions. A computer system, such as the one being described, will also operate with various input and output devices connected thereto.

The computer system operates in response to the one or more processors executing one or more sequences of one or more instructions contained in the main memory. Such instructions may be read into the main memory from another computer-readable medium, such as a storage device. Execution of the sequences of instructions contained in the main memory causes the processor to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor for execution. Such a medium may take many forms, including but not limited to, non-volatile media, volatile media, and transmission media. Non-volatile media includes, for example, optical or magnetic disks. Volatile media includes dynamic memory, such as the main memory. Transmission media includes coaxial cables, copper wire and fiber optics, including the wires that comprise the bus. Transmission media can also take the form of acoustic or light waves, such as those generated during radio-wave and infrared data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read. The computer system can also send messages and receive data, including program code, through one or more networks.

In the future, the invention may be used for other industries. The framework will not change significantly. However, the predefined lists and other default content would be modified to relate to the pertinent industry, such as telecommunications, medical, automotive, and other industries.

It is anticipated that various changes may be made in the arrangement and operation of the system of the present invention without departing from the spirit and scope of the invention, as defined by the following claims.

What is claimed is:

1. A computer software system for managing risk, comprising:
an executive dashboard menu, for providing a top-level mechanism for identifying and quantifying risk factors;
a console menu, for directing a user to specific software tabs suitable for inputting and managing risk data;
a reports menu, for directing a user to specific software tabs suitable for formatting and reviewing the inputted data; and
a maintenance menu, for entering information portions of static risk data.

2. The system of claim 1, further comprising:
client access to the system is provided by a manager.

3. The system of claim 2, further comprising:
the manager is an entity that has been authorized to add clients.

4. The system of claim 3, further comprising:
the manager can access all client information, and also has access to default lists used to populate the various tables used by the client.

5. The system of claim 1, wherein the executive dashboard further comprises a risk profile chart, audit findings chart, control gap chart, and vendor review table.

6. The system of claim 1, further comprising:
an audit findings chart for displaying reportable items that require corrective action.

7. The system of claim 6, wherein the audit findings chart summarizes data into various severities and the percent of corrective action completed.

8. The system of claim 1, further comprising:
a control gap chart for representing planned mitigation strategies that were identified during the risk assessment process but have not yet been implemented.

9. The system of claim 1, further comprising:
a vendor table for displaying all of a Client's vendors and providing a reference relating to the Client's oversight of critical service providers, comprising at least the last time a vendor was formally reviewed, whether that review was successful or unsuccessful, and timeframe for the next review.

10. The system of claim 1, further comprising:
a business continuity tab for business continuity planning a plurality of business processes.

11. The system of claim 1, further comprising:
a plurality of business continuity edit screens for identifying a Client's recovery point objectives and maximum tolerable downtimes.

12. The system of claim 1, further comprising:
a business recovery tab for allowing an end-user to document specific recovery strategies along with recovery procedures, including high-level managerial plans for business continuity.

13. The system of claim 1, further comprising:
a backup requirements tab for identifying computer files that need to be backed up, the frequency of the backups, who is to perform the backups, and user comments.

14. The system of claim 1, further comprising:
an offsite requirements tab for identifying items a Client needs to store offsite for business continuity purposes and location of the offsite storage.

15. The system of claim 1, further comprising:
a risk assessment tab for documenting specific risks and associated mitigation strategies.

16. The system of claim 15, wherein all risks with a residual risk level that exceeds the approved risk tolerance level are included in an unmitigated risk report.

17. The system of claim 1, further comprising:
an audit findings tab for documenting audit findings which may include findings from one or more sources selected from: internal staff, external audit firms, external consulting firms, and regulatory agencies.

18. The system of claim 1, further comprising:
a vendor review tab for allowing a Client to document their oversight of critical vendors.

19. The system of claim 1, further comprising:
a characterization report tab for detailing an association between specific business processes and specific information assets including one or more of hardware, software, personnel, and vendors.

20. The system of claim 1, further comprising:
a business continuity tab for providing access to a plurality of business continuity related reports.

21. The system of claim 1, further comprising:
a business impact assessment report for identifying recovery strategies, backup requirements, offsite storage requirements, and the supporting hardware, software, personnel, and vendors for each business process utilized by a client.

22. The system of claim 20, further comprising:
a recover procedures report tab for detailing the recovery procedures that were entered into the business continuity tab.

23. The system of claim 20, further comprising:
a backup requirements report tab for detailing computer files identified in the business continuity tab required to restore a business process in the event of a disruption.

24. The system of claim 1, further comprising:
an offsite storage requirements report tab detailing pertinent items, including one or more of computer files, documents, supplies, required to restore a business process in the event of a disruption.

25. The system of claim 1, further comprising:
a personnel listing report tab arranged in alphabetical order and containing a listing of client personnel comprising contact information for each person identified.

26. The system of claim 1, further comprising:
an audit/test plan tab for providing a listing of the audit objectives of a review and identifying the responsible party for performing the review along with the frequency of the review.

27. The system of claim 1, further comprising:
an audit/test objectives report for detailing one or more mitigation strategies to consider during an audit.

28. The system of claim 1, further comprising:
an audit findings report for detailing the findings from various reviews which documents the priority level of the finding, the responsible party for implementing corrective action, the due date for corrective action to be completed, and the percent of corrective action completed.

29. The system of claim 1, further comprising:
a risk management report tab for documenting the risks that exceed an approved risk tolerance level, comprising information relating to a specific risk that was added during a risk assessment

30. The system of claim 1, further comprising:
a security requirements checklist report for displaying all mitigation strategies in a governing document that will formally implement a specific mitigation strategy.

31. The system of claim 1, further comprising:
a control gap report for detailing mitigation strategies that are not currently implemented and assisting a client in monitoring the status of the mitigation strategy implementation.

32. The system of claim 1, further comprising:
a maintenance menu for identifying Client operating locations and information assets associated with a business process.

33. The system of claim 32, further comprising:
a characterization tab for providing an interface to associate the information assets to a specific business process.

34. A method comprising performing a machine-executed operation involving instructions, wherein the machine-executed operation as at least one of:
a) storing the instructions onto a machine-readable storage medium; and
b) executing the instructions;
wherein the instructions are instructions which, when executed by one or more processors, cause the one or more processors to perform the steps of:
providing a top-level mechanism for identifying and quantifying risk factors;
directing a user to specific software tabs suitable for inputting and managing risk data;
directing a user to specific software tabs suitable for formatting and reviewing the inputted data; and
entering information portions of static risk data.
